(19) United States
(12) Patent Application Publication
(10) Pub. No.: US 2026/0118822 A1
(43) Pub. Date: Apr. 30, 2026

(54) CONTROL OF A REPLICATION PROCESS OF A MASTER HOLOGRAPHIC OPTICAL ELEMENT FOR VARIABLE INTENSITY OR POLARISATION

(71) Applicant: Carl Zeiss Jena GmbH, Jena (DE)

(72) Inventors: Markus GIEHL, Jena (DE); Christian BLECHSCHMIDT, Jena (DE)

(73) Assignee: Carl Zeiss Jena GmbH, Jena (DE)

(21) Appl. No.: 19/109,854

(22) PCT Filed: Sep. 7, 2023
(86) PCT No.: PCT/EP2023/074646

§ 371 Date: Mar. 7, 2025

(30) Foreign Application Priority Data
Sep. 8, 2022 (DE) 10 2022 122 854.1

(51) Int. Cl. G03H 1/20; G03H 1/04

(52) U.S. Cl. CPC G03H 1/202; G03H 1/0402; G03H 1/0486; G03H 2001/0439; G03H 2001/0491; G03H 2001/205; G03H 2222/31; G03H 2240/53

(57) ABSTRACT

The invention relates to techniques for producing a holographic optical element, HOE, by replication of a master HOE. More particularly, the invention relates to techniques for flexibly adjusting the diffraction efficiency of the HOE. An adjustable settable optical element (54) can be used to change the intensity and/or polarisation of light during an illumination process.

### RELATED APPLICATIONS

This application is a National Stage Application, filed under 35 USC § 371, of International Application No. PCT/EP2023/074646, filed Sep. 7, 2023, which claims priority from German Patent Application No. DE102022122854.1, filed on Sep. 8, 2022, each of which are hereby fully incorporated herein by reference.

### FIELD OF THE INVENTION

Various examples relate to techniques for producing a holographic optical element (HOE) by replicating a master HOE. Several examples relate in particular to techniques for variably adapting the illumination of the master HOE during replication.

### BACKGROUND OF THE INVENTION

HOEs are used in various fields of application. For example, HOEs can be used to implement a transparent screen. Areas of application include, for example, the use in a head-up display in an automobile or the integration of a holographic optical element in a mirror. HOEs are used to generate holograms.

One technique for producing HOEs is based on the use of a master HOE, which is used in an exposure process of the HOE to form the HOE. An example of a master HOE is a reflection free-beam volume HOE.

During the replication of the master HOE, the carrier layer (for example a photopolymer, which is arranged on a substrate) of the master HOE is arranged along the carrier layer of the HOE to be replicated (hereinafter simply “replicated HOE”). With exposure, the diffraction structure of the master HOE can then be replicated in the replicated HOE.

Such manufacturing methods which use replication of the master HOE for the production of the HOE can, for example, use a roll-to-roll process, in which the master HOE and the HOE are arranged on a respective roll, which rolls are rotated synchronously with one another, so that a partial region of the master HOE extends in each case along a corresponding partial region of the replicated HOE. Another technique is the flatbed process, in which the master HOE and the replicated HOE are fixed on a respective planar or flat carrier, so that the entire surface of the respective carrier layers extend along one another.

In such production processes, the diffraction efficiency of the replicated HOE may deviate from specific target specifications. This may reduce the quality of the hologram generated by the replicated HOE. Furthermore, it is not conventionally possible in such production processes to deviate between the replicated HOE and the master HOE, for example in order to allow a different colour distribution.

### SUMMARY OF THE INVENTION

There is therefore a need for improved production processes for HOEs. In particular, there is a need for improved production processes that enable a high quality for the replicated HOE.

A control apparatus for an exposure apparatus is described. The exposure apparatus is used to produce a HOE. The HOE is produced by replicating a master HOE within the framework of an exposure process performed by the exposure apparatus. During the exposure process, a carrier layer of the master HOE is arranged along a carrier layer of the HOE.

The control apparatus comprises at least one processor and a memory. The at least one processor is configured to load program code from the memory and to execute the program code.

The at least one processor is further configured to control at least one light source of the exposure apparatus based on the program code such that the light source emits light with at least one wavelength along a beam path to a surface of the carrier layer of the master HOE.

For example, the at least one light source can emit light in the visible spectrum. Radiation in the ultraviolet or infrared range of the electromagnetic spectrum could also be emitted. The at least one light source may be a coherent laser light source. For example, a plurality of light sources which emit components of the light at different wavelengths could be used. For example, a light source could have 3 channels, such as red-green-blue (multi-channel light source).

The at least one processor is further configured to control a beam movement unit of the exposure apparatus based on the program code such that the beam movement unit moves the beam path during the exposure process in relation to the surface of the carrier layer of the master HOE.

For example, the angle of incidence could be tilted. For example, a light point could be moved over the surface of the carrier layer. A scanning movement could be performed. Line scanning would be conceivable. It would be conceivable to use a galvo scanner that implements a step mode, i.e. remains in one position and then moves to a next stable position. It would be possible for the beam movement unit to scan a beam path of the light over the surface of the carrier layer of the master HOE. Alternatively, or in addition, it would be conceivable that the beam movement unit moves a reference point with reference to the master HOE arranged along the beam path and at a distance from the surface of the carrier layer along a curved path curve during the exposure process. The reference point could be arranged, for example, in a scanning mirror or a deflection mirror. In particular, the angle of incidence of the beam path on the surface of the carrier layer of the master HOE during the exposure process can be varied thereby. The beam movement unit can be used to move a light point of the light on the master HOE. This means that the master HOE is not illuminated over a large area, but is illuminated bit-by-bit by moving the light point. This means that the exposure of the HOE is not done in a “single-shot” method but bit-by-bit.

Furthermore, the at least one processor is configured to control at least one adjustable optical element, arranged in the beam path, of the exposure apparatus based on the program code. As a result, the at least one adjustable optical element changes during the exposure process the intensity and/or the polarization of the light over time. The at least one adjustable optical element can therefore be a filter that changes the intensity or the polarization.

The master HOE may be formed in a photopolymer which is part of the carrier layer. The carrier layer could also additionally comprise a carrier material. The carrier layer could be film-based. What is known as a volume HOE could be used.

The HOE can be formed in a photopolymer which is part of the corresponding carrier layer. The carrier layer could also additionally comprise a substrate. The carrier layer could be film-based. A so-called volume HOE could be used.

It is possible to produce a diffraction structure in the HOE based on the diffraction structure in the master HOE by way of the replication. A copy can be made, but no 1:1 copy is required. The diffraction structure corresponds to a local variation in the refractive index, for example due to different chain lengths or a different degree of chain formation of polymers in a corresponding layer.

Illuminating the master HOE enables the exposure of the replicated HOE. With a specific dose of light, this can result in a diffraction efficiency in the replicated HOE. The diffraction structures are copied from the master HOE to the replicated HOE. The replication efficiency of the master HOE describes the ratio between (i) the diffraction efficiency in the replicated HOE and (ii) the amount of light (dose) used to expose the replicated HOE. This means that the smaller/greater the replication efficiency, the greater/lower the light dose required to achieve a specific diffraction efficiency.

$$diffraction efficiency replicated HOE = replication efficiency \cdot amount of light \qquad ( 1 )$$

In the above equation, it should be considered that the proportionality between the diffraction efficiency of the replicated HOE and the required amount of light is limited to a linear range (what is known as the linear range of a material characteristic of the material of the replicated HOE linking the amount of light and the diffraction efficiency). The maximum achievable diffraction efficiency of the replicated HOE is typically in the range of 95% to 98% and is limited, for example, by the thickness of the HOE region (where the refractive index is modulated). When this maximum diffraction efficiency is reached, additional exposure does not increase the diffraction efficiency further. This is described by Kogelnik's theory, as it is known.

The replication efficiency can have a plurality of influencing variables. Some examples are summarized in TAB. 1.

| | | |
|---|---|---|
| I | Material characteristic of the | The material characteristic describes an ideally |
| | material | achievable diffraction efficiency in the replicated |
| | | HOE when exposed to a specific dose. |
| | | However, due to various influencing factors, |
| | | the actual diffraction efficiency in the replicated |
| | | HOE lags behind the diffraction efficiency that |
| | | is ideally achievable by the material characteristic |
| | | curve. These influencing factors are listed |
| | | below as examples II et seq. |
| II | Diffraction efficiency of the | The diffraction efficiency of the master HOE |
| | master HOE | can influence the replication efficiency. The |
| | | diffraction efficiency in the master HOE is |
| | | typically less than 100%, i.e. some of the incident |
| | | light does not contribute to replication at all. |
| | | Moreover, the diffraction efficiency of the |
| | | master HOE may vary due to structural properties |
| | | of the master HOE as a function of the position |
| | | on the master HOE, e.g. when the thickness of |
| | | the refractive-index-modulated region varies |
| | | locally or the degree of the chain formation of |
| | | polymers varies. This results in a location- |
| | | dependency of the replication efficiency. |
| | | As a general rule, the diffraction structures are |
| | | volume gratings (Bragg planes) that manifest |
| | | in a variation in the refractive index. The diffraction |
| | | efficiency results from a combination of the |
| | | thickness of the material (i.e. number of |
| | | planes) and the Δn, i.e. the intensity of the |
| | | modulation (deviation of the refractive-index |
| | | variation). As a rule, the film thickness and re- |
| | | fractive-index modulation are selected in such |
| | | a way that a diffraction efficiency of greater |
| | | than 0.9 is theoretically possible. Lower diffraction |
| | | efficiencies are possible if the modulation |
| | | varies locally during the master production |
| | | (e.g. due to locally different energy inputs |
| | | during the production); and/or the material |
| | | thickness fluctuates sharply; and/or additional |
| | | parasitic gratings are present (reflections, |
| | | scattering structures, etc.), which “steal” modulation |
| | | from the used grating. These are all variations |
| | | in structural properties in the master HOE that |
| | | can influence the diffraction efficiency and thus |
| | | the replication dose. |
| III | Polarization | The replication efficiency is also influenced by |
| | | the polarization of the light, specifically by the |
| | | orientation of the polarization in relation to the |
| | | surface of the carrier layer of the master HOE |
| | | (the polarization has an influence on both the |
| | | Fresnel reflections and the interference during |
| | | the exposure). |
| | | For example, at specific angles (near Brewster |
| | | angles), the loss of reflection from Fresnel |
| | | reflections is lower with p-polarization, but the |
| | | interference contrast is better with s-polarization. |
| | | The orientation of the polarization plane is |
| | | changed in particular when the angle of |
| | | incidence of the light on the master HOE changes. |
| | | The angle of incidence may in turn change if |
| | | the light point is moved over the surface of the |
| | | carrier layer of the master HOE during the ex- |
| | | posure. This has an influence on the replication |
| | | efficiency, which in turn can then have a |
| | | location dependency. |
| | | The replication efficiency may vary depending |
| | | on the polarization of the light. For example, a |
| | | higher replication efficiency can be obtained for |
| | | s-polarized light than for light with p-polarization |
| | | or a portion of p-polarization. |
| | | This means therefore that the properties of the |
| | | incident light can have an influence on the |
| | | replication efficiency. In addition to polarization as |
| | | a property of the incident light, the wavelength |
| | | of the incident light may also have an influence |
| | | on the replication efficiency; this is described |
| | | below in IV. |
| IV | Wavelength | When light having a wavelength that is shifted |
| | | with respect to that of the periodicity of the |
| | | refractive-index modulation (“wavelength offset”) |
| | | is used, the replication efficiency decreases. |

TAB. 1: Various influencing variables of the replication efficiency. The diffraction efficiency is explained in more detail below. Microscopically, diffraction efficiency can be explained by an amplitude of the refractive-index variation, which can depend, for example, on a degree of the chain-formation of polymers. Macroscopically, diffraction efficiency can be defined by the portion of the diffracted light with respect to the total incident (coherent) light:

$$diffraction efficiency = \frac{amount of diffracted light}{total amount of light}$$

The more polymers are chained, the higher is the refractive-index modulation, and the higher is the diffraction efficiency.

The dose of light used to expose the replicated HOE is influenced by the dwell time of a light point at the respective location on the surface of the carrier layer, and by the intensity of the light.

By providing the at least one adjustable optical element, it is possible to flexibly vary the intensity and/or the polarization of the light during the exposure process, i.e. as a function of the position of the light point on the surface of the carrier material of the master HOE. For example, manufacturing fluctuations that lead to a locally variable replication efficiency (see TAB 1: Example II) can be compensated. It would be possible, alternatively or additionally, to compensate for a variation in the replication dose due to different angles of incidence and thus different angles between a polarization plane of the light in relation to the surface of the carrier layer of the master HOE (see TAB. 1: Example III). Alternatively or in addition, it would be conceivable to selectively use different intensities in order to obtain different diffraction efficiencies for the HOE, in particular deviating from the diffraction efficiencies of the master HOE. Overall, such effects can be used to ensure that the hologram generated by the HOE has a particularly high quality, i.e. has a specific diffraction efficiency that corresponds to a target specification. In particular, it can be ensured that the diffraction efficiencies of different wavelength components have a desired ratio in relation to one another. Negative influences from replication can be reduced.

As a general rule, the intensity could be changed in absolute terms. This means, for example, that the intensity can be increased or decreased from one reference level to a specific absolute level. This can be done individually for a plurality of components that correspond to different wavelengths of the light. However, it would also be conceivable for the intensity to be changed equally for all components of the light. As a further general rule, it would be conceivable for the intensity of the different wavelength components of the light to be adjusted relative to one another. For example, if the intensities for redgreen-blue (RGB) components are 1:1:1 as a reference, an adjustment to e.g. 0.8:1.2:1 could be made.

For example, it would be conceivable for the at least one processor to be furthermore configured, based on the program code, to load control data. For example, the control data can show the change in polarization and/or in intensity as a function of time. The control data can indicate a correlation between the movement of the beam path in relation to the surface of the carrier layer and the change in the intensity and/or the polarization of the light. The control of the beam movement unit and the control of the at least one adjustable optical element are then effected in synchronized fashion based on the control data.

This therefore means that, depending on the position of a corresponding light point on the surface of the carrier layer of the master HOE and/or depending on the angle of incidence of the beam path on the surface of the carrier layer of the master HOE, a different intensity and/or a different polarization of the light can be set. This results in a change in intensity and/or in polarization over time, because the light point is moved accordingly over time, which means that the position and/or the angle of incidence of the beam path on the surface of the carrier layer changes as a function of time.

Such synchronization can be used in a targeted manner for different positions on the surface of the carrier layer to compensate for undesirable properties of the master HOE or the carrier layer. A local deviation between the master HOE and the HOE could also be selected.

For example, if the beam movement unit realizes a step mode, i.e. remains at each position and is then moved step-by-step between these positions (different from a continuous movement, such as it occurs in a resonantly operated scanning mirror), the at least one adjustable optical element could be controlled to change the intensity and/or polarization in connection with a step-by-step mode. For example, if a galvo scanner is moved, the intensity and/or the polarization could be changed at the same time.

For example, it would be conceivable for the at least one adjustable optical element, and the beam movement unit, to be controlled in such a way that its influence of the variation of structural properties of the master HOE on the diffraction efficiency (and thus on the replication efficiency, see TAB. 1: Example II) is reduced by the change in the intensity of the light during the exposure process. This means, for example, that a change in the diffraction efficiency by a specific value between two points on the surface of the carrier layer of the master HOE is not replicated, or is replicated only to a lesser extent, into the replicated HOE: If the diffraction efficiency varies between points A and B by 10 percentage points in the master HOE, the diffraction efficiency of the HOE could vary between the corresponding points A and B by only 5 percentage points.

For example, the diffraction efficiency might vary for different positions on the surface of the carrier layer of the master HOE due to variable structural properties—for example caused by manufacturing fluctuations or ageing or scratches. This means in practical terms: If all the positions on the surface of the carrier layer of the master HOE were illuminated with the same light dose, that is to say if, for example, the same intensity of the light were used for the exposure at all the different positions on the surface of the carrier layer of the master HOE (while the light point remains at the different positions on the surface for equal time periods), these different diffraction efficiencies of the master HOE would also cause correspondingly different diffraction efficiencies in the HOE (because the replication efficiency varies accordingly, see TAB. 1: Example 0). For example, the hologram generated by the replicated HOE would have different brightnesses or blurring or colour inhomogeneities such as a colour fringe. Such undesirable effects can be avoided by correspondingly adapting the intensity of the light during the exposure process in order to reduce or compensate for the variation in the diffraction efficiency. The at least one adjustable optical element and the beam movement unit can thus be controlled in such a way that the influence of the variation of structural properties of the master HOE on the diffraction efficiency is reduced by the change in the intensity of the light during the exposure process. This enables imperfections of the master HOE to be compensated for. A master HOE can be used longer.

Another factor influencing the efficiency of the replication is the orientation of the polarization plane of the light (for linearly polarized light) in relation to the surface of the carrier material of the master HOE, see TAB. 1: Example III. For example, there may be an s-polarization, a p-polarization, or a mixture thereof. The orientation of the polarization plane is changed when the angle of incidence of the light on the master HOE changes. The angle of incidence may in turn change if the light point is moved over the surface of the carrier layer of the master HOE during the exposure. This has an influence on the replication efficiency. It is possible for the at least one adjustable optical element and the beam movement unit to be controlled in such a way that the orientation of the polarization with respect to the surface of the carrier layer of the master HOE is stabilized. This means that the control can be effected in such a way that the influence of the movement of the beam path on a change in the orientation of the polarization of the light in relation to the surface of the carrier layer of the master HOE during the exposure process is reduced. In short, this thus reduces the influence of variable angles of incidence (due to the movement of the beam path) on the replication efficiency. This enables more flexible movements of the beam path by way of the beam movement unit. For example, this enables the replication for curved master HOEs.

Such and further effects are also achieved by means of further methods and apparatuses:

A method for configuring a production method for producing a HOE by replicating a master HOE within the framework of an exposure process carried out by an exposure apparatus is disclosed. During the exposure process, a carrier layer of the master HOE is arranged along a carrier layer of the HOE. The method comprises the generation of control data for at least one adjustable optical element of the exposure apparatus, with the optical element being arranged in a beam path of light used for the replication. By means of the control data, the at least one adjustable optical element can be controlled such that it changes during the exposure process at least one of an intensity and a polarization of the light over time.

An apparatus comprises at least one processor and a memory. The at least one processor is configured to load and execute program code from the memory. The at least one processor is furthermore configured to execute the method for configuring the production process based on the program code.

A method for controlling an exposure apparatus for producing a HOE by replicating a master HOE is disclosed. The replication is performed within the framework of an exposure process performed by the exposure apparatus. During the exposure process, a carrier layer of the master HOE is arranged along a carrier layer of the HOE. The method comprises controlling at least one light source of the exposure apparatus in such a way that it emits light having at least one wavelength along a beam path towards the surface of the carrier layer of the master HOE during the exposure process. In addition, the method comprises the controlling of a beam movement unit of the exposure apparatus such that it moves the beam path during the exposure process in relation to the surface of the carrier layer of the master HOE. In addition, the method comprises the controlling of at least one adjustable optical element of the exposure apparatus, with the former being arranged in the beam path, such that the at least one adjustable optical element during the exposure process changes at least one of an intensity and a polarization of the light over time.

A control apparatus for an exposure apparatus for producing a holographic optical element, HOE, by replicating a master HOE within the framework of an exposure process carried out by the exposure apparatus is disclosed. The exposure process uses light that is emitted from at least one light source of the exposure apparatus during the exposure process along a beam path to a surface of the carrier layer of the master HOE. During the exposure process, a carrier layer of the master HOE is arranged along a carrier layer of the HOE. The control apparatus comprises at least one processor and a memory, wherein the at least one processor is configured to load program code from the memory and to execute the program code. The at least one processor is configured to control a beam movement unit of the exposure apparatus based on the program code such that the beam movement unit moves the beam path during the exposure process in relation to the surface of the carrier layer of the master HOE. The at least one processor is further configured to control at least one of an adjustable optical element of the exposure apparatus, which is arranged in the beam path, the at least one light source, and the beam movement unit such that during the exposure process at least one of a dose and a polarization of the light is changed over time.

A corresponding method is also disclosed.

For example, a diode current through a laser diode could be varied in order to vary the intensity of the light.

For example, a scanning speed could be varied so that the dwell time of a light point on the surface is varied (for example at the same intensity of the light), so that the dose is increased or decreased in that way.

The features set out above and features that are described below can be used not only in the corresponding combinations explicitly set out, but also in further combinations or in isolation, without departing from the scope of protection of the present invention.

### BRIEF DESCRIPTION OF THE DRAWINGS

FIG. 1 shows a flowchart of an exemplary method for producing a HOE.

FIG. 2 schematically illustrates a system for exposing a HOE within the framework of a replication of a master HOE according to various examples.

FIG. 3 shows a flowchart of an exemplary production method.

FIG. 4 schematically illustrates the illumination of a master HOE based on a corresponding map according to various examples.

FIG. 5 schematically illustrates the illumination of a master HOE based on a corresponding map according to various examples.

FIG. 6 shows a flowchart of an exemplary method for producing a HOE by replicating a master HOE.

FIG. 7 schematically illustrates the illumination of a master HOE in a target surface shape according to various examples.

FIG. 8 schematically illustrates the illumination of the master HOE from FIG. 7 in an exposure surface shape that differs from the target surface shape, according to various examples.

FIG. 9 schematically illustrates the illumination of the master HOE from FIG. 7 in the exposure surface shape of FIG. 8, wherein a reference point of a beam path of light moves along a trajectory.

FIG. 10 shows a roll-to-roll process.

FIG. 11 schematically illustrates a flatbed replication process for exposing a HOE by replication of a master HOE according to various examples.

FIG. 12 schematically illustrates the master HOE from FIG. 12 with a planar illumination surface shape according to various examples.

FIG. 13 is a side view of the master HOE from FIG. 11.

FIG. 14 is a further side view of the master HOE from FIG. 11.

FIG. 15 illustrates aspects in connection with a beam movement unit according to various examples.

FIG. 16 schematically illustrates a p-polarization.

FIG. 17 schematically illustrates an s-polarization.

FIG. 18 schematically illustrates an exposure apparatus according to various examples.

FIG. 19 schematically illustrates an exposure apparatus according to various examples.

FIG. 20 schematically illustrates an exposure apparatus according to various examples.

FIG. 21 schematically illustrates an exposure apparatus with a sensor according to various examples.

FIG. 22 schematically illustrates an exposure apparatus with a sensor according to various examples.

FIG. 23 schematically illustrates an exposure apparatus with a sensor according to various examples.

FIG. 24 is a flowchart according to various examples, which allows intensity stabilization during the exposure process to a time-variable target intensity value, for example.

### DETAILED DESCRIPTION OF THE INVENTION

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs denote identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements as illustrated in the figures can also be implemented as an indirect connection or coupling. A connection or coupling can be implemented in a wired or wireless manner. Functional units can be implemented as hardware, software or a combination of hardware and software.

Techniques for producing HOEs are described below. For example, volume HOEs or surface HOEs can be produced by means of the techniques described herein.

The techniques described herein are based on replicating a master HOE to produce a replicated HOE. For the production of the master HOE, a corresponding exposure process can be used prior to it. Several examples described herein relate in particular to the exposure of the replicated HOE by replicating the master HOE.

The replication can take place, for example, by means of a scanning method. Here, a laser spot is brought into a line or other shape by a fast-scanning element (such as a scanning mirror), which in turn is moved over the master HOE. So in a snapshot, a laser spot moves on the master. More generally, the beam path of the light (which may include a plurality of components corresponding to different wavelengths) is moved by a beam movement unit over the surface of the carrier material of the master HOE during the exposure process. In other words, during the exposure process, different regions of the replicated HOE are exposed bit-by-bit by way of the movement of the light point.

Various examples described herein are based on the finding that it may be desirable for various reasons to vary the intensity and/or the polarization of the light used for the exposure during the exposure process by means of an adjustable optical element. Some scenarios are listed in TAB. 2.

| | BRIEF DESCRIPTION | EXEMPLARY DETAILS |
|---|---|---|
| I | Compensation for | A master HOE ideally has a homogeneous diffraction |
| | variations in the replication | efficiency of no less than 0.8, which is also homogeneously |
| | efficiency due to variation | distributed for all three wavelength ranges in the |
| | in structural properties | case of red-green-blue (RGB) master HOEs. In reality, |
| | of the master | however, manufacturing fluctuations, scratches, ageing, |
| | HOE | etc. lead to variations in structural properties and |
| | | thus to inhomogeneous distributions of the diffraction |
| | | efficiency, which can also vary from wavelength to |
| | | wavelength. The inhomogeneities of the diffraction |
| | | efficiency of the master HOE are likewise replicated |
| | | without compensation by adapting the intensity (because |
| | | the diffraction efficiency influences the replication |
| | | efficiency, see TAB. 1: Example II). Depending on the |
| | | application, these efficiency fluctuations manifest in |
| | | colour gradients or local brightness differences of the |
| | | hologram or replica. |
| | | It may also be the case that there is actually a |
| | | homogeneous diffraction efficiency, but the replication |
| | | efficiency is still influenced; for example because the |
| | | contact between the carrier layers of the master HOE and |
| | | of the replicated HOE varies slightly during the replication |
| | | process due to different elasticities of the master |
| | | HOE, etc. Such inhomogeneities of the replication |
| | | efficiency of the master HOE (which are not due to the |
| | | variation in the diffraction efficiency) can also be |
| | | compensated by means of the techniques described herein. |
| | | It is possible to compensate for the inhomogeneities of |
| | | the replication efficiency during the exposure by appropriate |
| | | variation in the intensity of the light (meaning that |
| | | the inhomogeneities of the replication efficiency (especially |
| | | the diffraction efficiency) do not occur, or occur |
| | | only to a lesser extent than in the master HOE, in the |
| | | replicated HOE). |
| | | For this purpose, the fact that the diffraction efficiency |
| | | of a volume hologram depends, among other things, on |
| | | the refractive-index modulation in the volume is used, |
| | | for example. If a lower exposure dose (due to lower |
| | | intensity) causes a lower modulation to be exposed in, |
| | | the diffraction efficiency also decreases. This homogeneity |
| | | optimization is therefore at the expense of the absolute |
| | | value of the diffraction efficiency of the HOE. |
| | | However, since HOEs obtained as replicas of a master |
| | | HOE generally have, in principle, a higher efficiency |
| | | than the master HOE (this has manufacturing-related |
| | | reasons), a better homogeneity of the diffraction |
| | | efficiency of the HOE compared with the master HOE can |
| | | be achieved with a similar absolute diffraction |
| | | efficiency. |
| | | Depending on the structural properties of the master |
| | | HOE, the light (comprising, for example, three components |
| | | for RGB wavelengths) can be modulated so |
| | | quickly that the laser spot in the snapshot has different |
| | | intensities for the RGB components of the light at |
| | | different locations of the master HOE. This means that the |
| | | adjustable optical element can be controlled such that |
| | | the intensities of the components of the light that |
| | | correspond to different wavelengths are changed relative to |
| | | one another during the exposure process. |
| II | Compensation for variations | The movement of the beam path in relation to the surface |
| | in the replication | of the carrier layer of the master HOE may cause |
| | efficiency due to | different polarizations of the light locally with respect to |
| | variations in the angle of | the plane of incidence of the beam path to the master |
| | light incidence | HOE. |
| | | Since in practice a large number of master HOEs with |
| | | different reference waves can occur and therefore an |
| | | individual antireflective coating of the master plate is |
| | | very complex and possibly not possible, large Fresnel |
| | | losses can occur at correspondingly large angles of |
| | | incidence if there is no suitable compensation. Large |
| | | Fresnel losses occur when a significant p-component |
| | | of the polarization is present. |
| | | By rotating the polarization to match the current |
| | | position of the beam path of the light or to match the angle |
| | | of incidence of the light on the surface of the carrier |
| | | material of the master HOE, these losses (reduced |
| | | replication efficiency, see TAB. 1: Example III) may be |
| | | reduced due to the variation in the polarization direction |
| | | of the light or the interference contrast may be |
| | | improved due to the s-polarization, which interferes |
| | | better. |
| III | Adapting the replicated | Sometimes it may be desirable, for example, to vary the |
| | HOE to the master | brightness of the hologram generated by the replicated |
| | HOE | HOE compared with specifications defined by the master |
| | | HOE. Sometimes, for example, it might be desirable |
| | | for the hologram to have fewer blue components than |
| | | specified by the master HOE. A relative adaptation of |
| | | the colour distribution of the hologram may be desired. |
| | | Such effects can be achieved by varying the intensity |
| | | of the light during the exposure process. In particular, |
| | | for example, the colour distribution of the hologram can |
| | | be adjusted by varying the intensities of different |
| | | wavelength components of the light relative to one another |
| | | during the exposure process. |
| IV | Compensation for | If the beam path of the light is moved in relation to the |
| | different dwell times | surface of the carrier layer during the exposure |
| | | process, in particular a light point can be moved over the |
| | | surface of the carrier layer of the master HOE. For this |
| | | purpose, for example, a scanning mirror can be used |
| | | that is moved translationally, for example using a robot |
| | | arm or by means of a linear adjustment stage. The |
| | | dwell time of the light point at different positions on the |
| | | master HOE can vary here, for example due to hardware |
| | | limitations of the beam movement unit. Sometimes |
| | | a longer dwell time may occur at inflection points |
| | | of a scanning movement than in the central region of a |
| | | scan line. This influences the dose of the exposure. |
| | | Such an influence of the dwell time of the light point on |
| | | the dose of the exposure can be compensated in some |
| | | examples by the change in the intensity of the light |
| | | during the exposure process over time. |
| V | Compensation for different | It may be the case that the diffraction efficiency of the |
| | diffraction efficiencies | replicated HOE exhibits a variation as a function of the |
| | in the carrier | position on the surface of the carrier material of the |
| | material of the | HOE which differs from the corresponding diffraction |
| | replicated HOE | efficiency of the master HOE. This can be caused, for |
| | | example, by a manufacturing-related variation in the |
| | | carrier material of the HOE. For example, this could be |
| | | caused by a thickness fluctuation. Such variations in |
| | | the diffraction efficiency of the HOE can also be |
| | | compensated by changing the intensity of the light during |
| | | the exposure process of the master HOE over time, |
| | | correlated with the respective position on the surface of |
| | | the carrier material of the HOE. |
| VI | Multiple master HOEs | Situations may occur where a plurality of master HOEs |
| | on one master plate | are disposed on a common master plate. For example, |
| | | a one-dimensional or two-dimensional array of master |
| | | HOEs could be disposed on a master plate. In such a |
| | | case, it may be desirable to change the intensity of the |
| | | light between the exposure processes of the different |
| | | master HOEs, for example to adjust a ratio of the intensity |
| | | of the different wavelength components of the light |
| | | relative to one another. In this way, the replicated |
| | | HOEs that are assigned to the different master HOEs |
| | | can be exposed differently from one another and each |
| | | matched individually to the respective master HOE. |

TAB. 2: Several exemplary scenarios for changing the intensity and/or the polarization over time during the exposure process. In practical examples, the different scenarios can be combined. For example it would be conceivable for the polarization adaptation from Scenario II for large angles of incidence to be combined with the local intensity adaptation according to Scenario III, with the result that Fresnel losses are additionally achieved by increasing the power at large angles of incidence.

It is thus evident from TAB. 2 that, for example, a distinction is made between the scenario in which an imperfect master HOE (e.g. inhomogeneity of the mixture of the RGB components of the light) is to be compensated—Scenario I—and the case where a perfect master HOE is to be exposed differently (spatially resolved) for other reasons, for example in order to compensate for inhomogeneities of the replication material and/or of the illumination later—Scenario V. A mixture of both cases is also conceivable.

Modulation frequencies in the kHz or MHz range can be used to change the intensity of the light during the exposure, which can be achieved, for example, by means of acousto-optic elements such as acousto-optic modulators (AOM) or acousto-optic filters (AOTF) as examples of adjustable optical elements for changing the intensity. Such a modulation frequency is sufficiently high to change the intensity quickly compared with the movement of the light point over the surface of the carrier material of the master HOE. Typically, the beam movement unit is controlled in the kHz range, i.e. with a few 100 Hz, for example. As a general rule, the beam movement unit can be controlled with a smaller signal bandwidth than the signal bandwidth used for controlling the adjustable optical element—e.g. a factor of 3 to 4 can lie between the signal bandwidths. In summary, a corresponding signal bandwidth for controlling the adjustable optical element can lie in the megahertz range, for example, when the beam movement unit is controlled with a signal bandwidth in the kilohertz range.

In some variants, it is conceivable that the intensity is changed during the exposure process with a control loop. This means that (using a suitable sensor, such as a photodiode) a measurement value can be obtained that indicates the intensity of the light used to replicate the master HOE. This measurement value can then be used to check whether the actual intensity of the light deviates from a target intensity. As described above, this target intensity can be varied during the exposure process. Such a control loop can be implemented in software and/or hardware. For example, the target intensity can be output as program output of a software program; and the control loop can then be implemented in hardware.

Modulation frequencies in the MHz range can also be used for changes in the polarization of the light during the exposure, which can be achieved, for example, by a Pockels cell or a lambda/2 plate that can be flexibly introduced into the beam path.

As mentioned above in connection with a control loop for the intensity, it is alternatively or additionally conceivable that a control loop is used for changing the polarization during the exposure process.

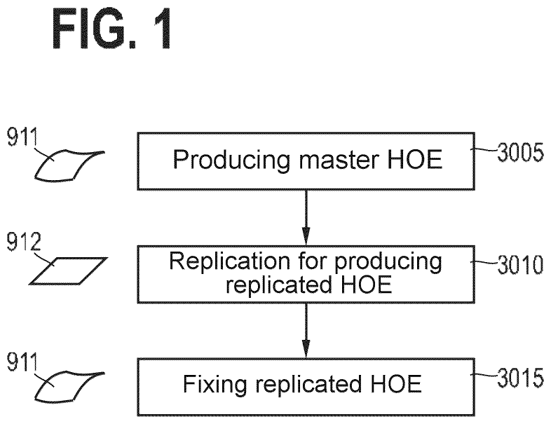

FIG. 1 illustrates a method for producing a replicated HOE according to various examples.

A master HOE is produced in box 3005. For this purpose, a corresponding photopolymer is exposed, which is located in or on a carrier layer of the master HOE. For the exposure, an object beam and a reference beam of corresponding light can be used, which are formed phase-coherently to one another. An analogue exposure could be performed, in which the object generates the object beam. A digital exposure with a pixelated light modulator and a stitching method could also be used.

FIG. 1 shows that the master HOE (or more precisely the carrier material of the master HOE) in box 3005, that is, when the master HOE is exposed, has the target surface shape 911. This target surface shape 911 is schematically illustrated in FIG. 1 as curved by way of example but could have any shape.

Then, in box 3010, the replicated HOE is exposed by replicating the master HOE. A roll-to-roll process or a flatbed copying process can be used.

In box 3010, the carrier material of the master HOE and the carrier material of the replicated HOE have an exposure surface shape 912; this is shown as an example in FIG. 1 as flat, but could also have a curvature.

The exposure surface shape 912 may be different from the target surface shape 911 in some examples. This can be compensated for by moving a reference point in the beam path on a curved trajectory during the exposure process. In particular, a variation in the angle of incidence of the beam path on the surface of the carrier material can be achieved thereby.

After the exposure process, the carrier layer of the replicated HOE is fixed again in the target surface shape 911, box 3015.

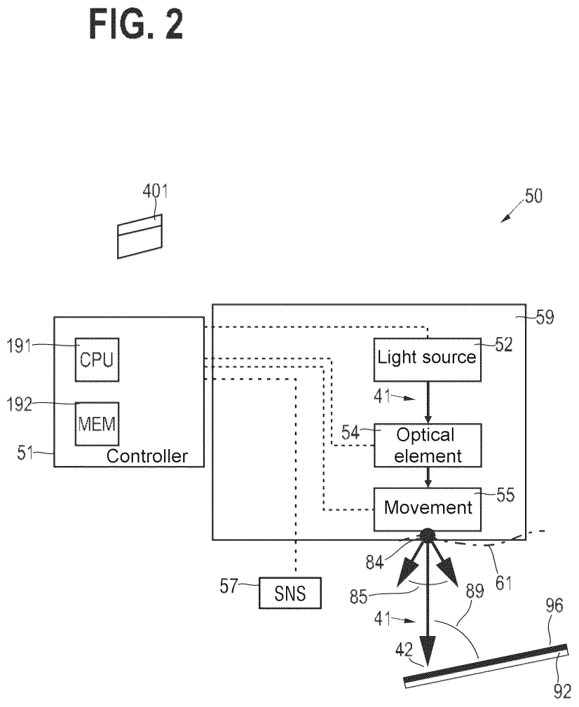

FIG. 2 illustrates aspects in connection with a system 50 which can be used to produce a replicated HOE 96 by replicating a master HOE 92. The system 50 can therefore be used in particular in connection with box 3010 according to the method from FIG. 1.

The system 50 comprises an exposure apparatus 59 and a control apparatus 51 for the exposure apparatus 59. The control apparatus 51 (or controller 51 for short) comprises a processor 191 and a memory 192. The processor 191 can load and execute program code from the memory 192 and then effect control of the exposure apparatus 59 based thereon.

The exposure apparatus 59 comprises a light source 52, for example a laser. The light source 52 transmits light along a beam path 41. The exposure apparatus 59 could, for example, comprise a plurality of light sources (not shown) for different components of the light which are associated with different wavelengths. The exposure apparatus 59 could, for example, comprise three light sources 52 for RGB components of the light. The light source can emit coherent light. The light may be in the visible spectrum or adjoining wavelength ranges, for example in the infrared or ultraviolet part of the electromagnetic spectrum.

The light illuminates a master HOE 92 to expose a replicated HOE 96 in this way. FIG. 2 schematically indicates that the carrier layer of the master HOE 92 is arranged along the carrier layer of the HOE 96.

The exposure apparatus 59 has an optical element 54 in the beam path. The optical element 54 can change the intensity and/or the polarization of the light. The optical element is adjustable, that is to say, the change in the intensity and/or the polarization of the light can be adjusted, that is to say, in particular varied over time during the exposure process. Examples of adjustable optical elements 54 are shown below in TAB. 3.

| | EXAMPLE | EXEMPLARY DETAILS |
|---|---|---|
| I | AOM | An AOM can change the degree of transmission of the light. For |
| | | this purpose, an optical grating is generated in a transparent |
| | | solid body using sound waves. The light beam is diffracted at this |
| | | grating and at the same time partially shifted in its frequency. |
| | | This changes the intensity of the light in transmission for the zero |
| | | order beam. The amount of light can be changed thereby in |
| | | equation 1. |
| | | For example, the exposure apparatus 59 could have a plurality |
| | | of AOMs for different wavelength components of the light; one |
| | | for each component of the light, for example one AOM for the R |
| | | component, one AOM for the G component and one AOM for the |
| | | B component. In such a scenario, it is conceivable that the AOMs |
| | | are arranged in each case at positions at which the various |
| | | components of the light have not yet been combined, that is to say, |
| | | in the corresponding partial beam paths which emanate from |
| | | corresponding light sources. In other words, the AOMs may be |
| | | arranged upstream with respect to a beam-combining element |
| | | for the partial beam paths. |
| II | AOTF | An AOTF can change the degree of transmission of the light for |
| | | a plurality of channels (multi-channel filter). Similar to the AOM, |
| | | optical gratings are also generated using sound waves, which |
| | | gratings can be adjusted for different wavelengths, however. |
| | | This changes the intensity of the light in transmission. The |
| | | amount of light can be changed thereby in equation 1. |
| | | In particular, a spectral filter curve can be variably adjusted so |
| | | that the intensity for different components of the light can be |
| | | adjusted independently of one another by means of a single AOTF. |
| | | This allows the AOTF to be located in a region of the beam path |
| | | where the different components of the light have been combined |
| | | (i.e. typically downstream of a beam-combining element for partial |
| | | beam paths associated with different components of the |
| | | light). |
| III | Pockels | The adjustable optical element 54 may comprise, for example, a |
| | cell | Pockels cell for changing the polarization of the light by rotating |
| | | the polarization plane. The electro-optical Pockels effect involves |
| | | the generation or modification of birefringence in an optical |
| | | medium by an electric field. This means that the polarization |
| | | level can be flexibly adjusted in relation to the surface of the |
| | | carrier material of the master HOE 95, e.g. depending on the angle |
| | | of incidence 89. This enables the replication efficiency to be set |
| | | in equation 1, see TAB. 1, Example III. |
| IV | Lambda/2 | It would also be conceivable for the adjustable optical element to |
| | plates | have one or more lambda/2 plates. These can be alternately |
| | | introduced into the beam path by means of a motor in order to |
| | | rotate the polarization plane in this way. This enables the |
| | | replication efficiency to be set in equation 1, see TAB. 1, Example III. |
| | | The polarization rotation can therefore be achieved, for example, |
| | | by a continuous rapid rotation of a rotary stage and appropriate |
| | | modulation (pulses) of the light source. The rotary stage has a |
| | | through hole in which a lambda/2 plate which rotates the polarization |
| | | is in turn mounted. In this case, the light can be switched |
| | | on and off to match the rotation of the stage, e.g. by means of |
| | | an AOM. |

TAB. 3: Several examples of the implementation of the adjustable optical element 54. As a general rule, the exposure apparatus 59 could also have a plurality of such adjustable optical elements, for example in a series circuit in the beam path 41 (but this is not illustrated in FIG. 2).

In addition, the system 50 also comprises a beam movement unit 55. The latter may comprise, for example, one or more motorized actuators and an optical element (e.g. a mirror and/or a prism and/or a lens element and/or a scanning mirror), which is arranged in the beam path and can be passive or active, i.e. can be adjustable or oriented fixedly. The motorized actuators can position the optical element according to a plurality of degrees of freedom. It may be possible to implement one or more degrees of freedom of translational movement. Alternatively or in addition, one or more degrees of freedom of rotational movement can be realized. This allows the beam path of the light to be moved. The actuator could be implemented, for example, by a robot arm having a plurality of adjustable axes. It would also be conceivable to implement it by means of a multi-axis optical linear adjustment stage. The actuator can be controlled by the controller 51. By means of the beam movement unit 55, it may be possible to move the beam path 41 in relation to the surface of the carrier layer of the master HOE 96 during the exposure process. For example, it may be possible to scan the beam path 41 by means of the beam movement unit 55, which is illustrated by a corresponding exit angle or scan angle 85. Alternatively or additionally, it may be possible to move a reference point 84, which is arranged along the beam path 41, along a curved path curve 61 (indicated by the dot-dashed line) by means of the beam movement unit 55.

The position of a corresponding light point 42 on the surface of the carrier layer of the master HOE 96 is changed during the exposure process by way of a movement of the beam path 41.

By way of a movement of the beam path 41 in relation to the master HOE 96, the angle of incidence 89 of the beam path 41 on the surface of the carrier layer of the master HOE 96 can be changed during the exposure process.

FIG. 2 also illustrates that a sensor 57 is present, which is configured to measure an intensity of the light in the region of the beam path 41. The sensor 57 is optional. For example, the sensor 57 can be a photodiode. The sensor 57 can output a signal which is indicative of the intensity of the light. The sensor 57 can therefore, for example, measure a luminous flux or light output. In the example of FIG. 2, the sensor 57 is connected to the controller 51. The sensor 57 could also be connected directly to the light source 52 and/or another adjustable element for setting the intensity (such as a Pockels cell or an AOTF). Based on a measurement signal of the sensor 57, it is possible to realize monitoring of the exposure. This means that the light output for the exposure of the HOE 92 can be monitored in particular. A closed control loop that adapts the control signals for an adjustable optical element in order to control the actual value of the light output at a target value of the light output can be implemented.

The controller may use control data 401 for controlling the adjustable optical element 54 and/or the light source 52 and/or the beam movement unit 55. In particular, (time-) synchronized control of the adjustable optical element 54 and of the beam movement unit 55 and optionally of the light source 52 can be effected. This means that time-correlated control is effected in such a way that, for example, depending on the position of a light point of the light on the surface of the carrier material of the master HOE, a different setting of the adjustable optical element 54 is selected. It is possible that these control data 401 are specifically assigned to a particular master HOE 96. This means that different control data 401 can be used for different master HOEs. This is due to the fact that the control data 401 can specifically compensate for specific properties of the master HOE. Details related to the generation of control data 401 are described below.

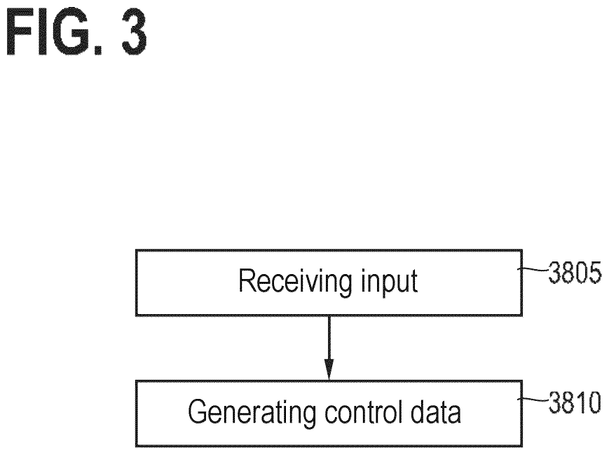

FIG. 3 is a flowchart of one exemplary method. FIG. 3 illustrates aspects related to the configuration of a production process for producing a HOE by replicating a master HOE. FIG. 3 illustrates in particular aspects relating to the generation of control data for an exposure apparatus by means of which the master HOE can be replicated. The control data can be, for example, the control data 401 for the exposure apparatus 59. In particular, reference is made below to the generation of control data 401 which allow control of at least one adjustable optical element, see TAB. 3. By generating control data 401, the intensity and/or the polarization of light used by the exposure apparatus to expose the master HOE for replication can be changed. This may be accomplished on the basis of one or more scenarios, such as those listed in TAB. 2.

In particular, it is possible that the control data couple the control of the beam movement unit and of the at least one adjustable optical element, that is to say that the light point is moved over the surface of the carrier layer of the master HOE and, in correlation therewith, the polarization and/or the intensity are changed.

First, one or more input data are received in box 3805. Based on the input data, the control data can then be generated in box 3810. The control data include instructions for the at least adjustable optical element so that it changes during the exposure process the intensity and/or the polarization of the light over time for replicating the master HOE.

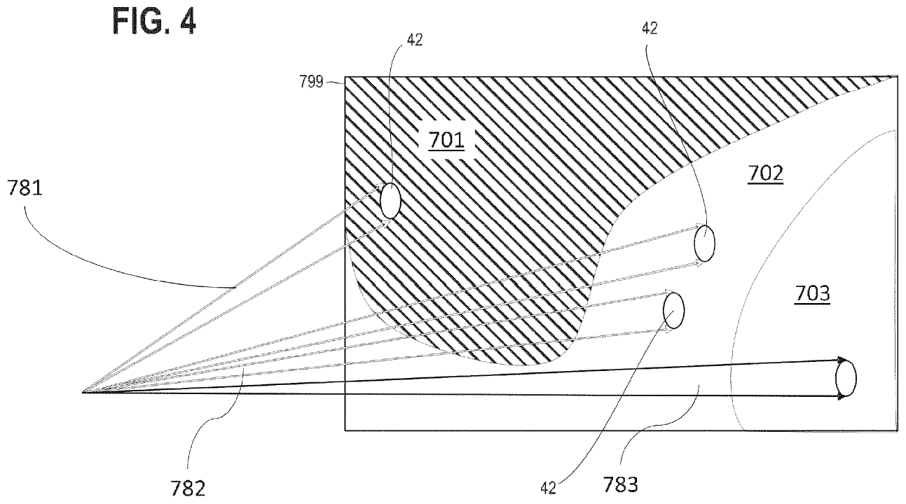

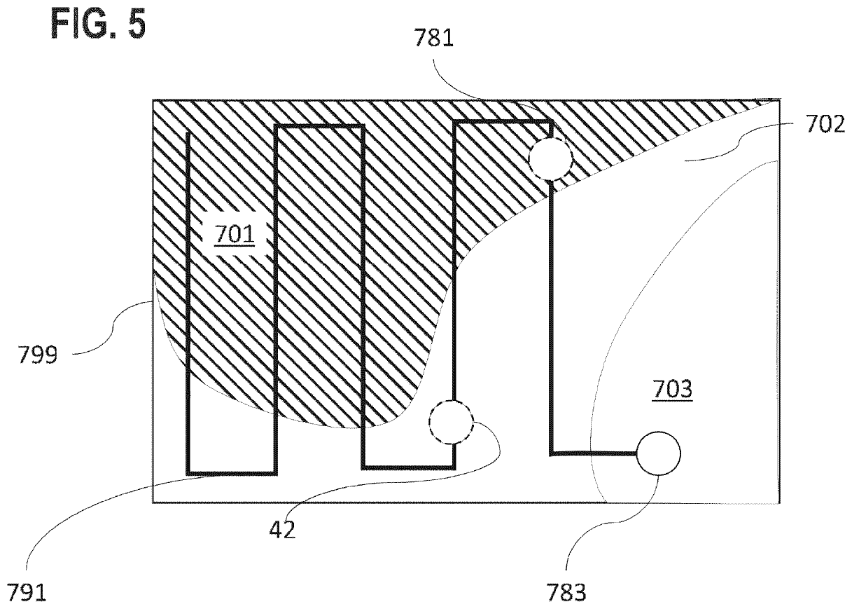

Different types of input data can be used to determine the control data. In particular, different input data can be taken into account depending on the scenario from TAB. 2. Below, in TAB. 4, a few examples of the taking into account of the input data that can be obtained in box 3805 are described.

| | EXAMPLE OF INPUT | |
|---|---|---|
| | DATA | EXEMPLARY DETAILS |
| I | Efficiency map | For example, it would be possible for the control data |
| | | to be determined based on a map of the master HOE, |
| | | which shows the diffraction efficiency as a function of |
| | | the position on the surface of the carrier layer of the |
| | | master HOE. The diffraction efficiency influences the |
| | | replication efficiency; see TAB. 1: Example II. A sample |
| | | map 799 is illustrated in FIG. 4. It shows different regions |
| | | 701-703 that are associated with different diffraction |
| | | efficiencies. |
| | | Such a map 799 can be obtained, for example, by suitable |
| | | measurement of the master HOE. In a laboratory |
| | | setup, the proportion of diffracted light relative to the |
| | | total amount of incident light can be measured, spatially |
| | | resolved for different positions on the master HOE, for |
| | | this purpose. |
| | | For example, such an inhomogeneous diffraction efficiency, |
| | | as described in connection with TAB. 2: Scenario |
| | | I, may be caused by manufacturing fluctuations. |
| | | The control data can then be determined using a predetermined |
| | | transfer function based on the map 799. |
| | | The transfer function can map values of the diffraction |
| | | efficiencies to intensities of the light. This predetermined |
| | | transfer function can map regions which are associated |
| | | with a comparatively low diffraction efficiency |
| | | to higher intensities of the light; and can map regions |
| | | which are associated with a comparatively high diffraction |
| | | efficiency to lower intensities of the light. |
| | | Thus, if in equation 1 the replication efficiency varies by |
| | | a specific absolute value due to the change in the |
| | | diffraction efficiency of the master HOE, this can be |
| | | compensated for by a corresponding variation in the intensity, |
| | | with the result that the diffraction efficiency in the |
| | | replicated HOE remains nominally the same. |
| | | In a simple case, the transfer function could describe a |
| | | linear characteristic. However, if the material characteristic |
| | | has non-linear components, these could be taken |
| | | into account in the transfer function - i.e. a change in |
| | | the diffraction efficiency must be compensated for by |
| | | an over- or under-proportional adjustment of the |
| | | intensity of the light. |
| | | This can be done in particular resolved for a plurality of |
| | | components of the light that correspond to different |
| | | wavelengths, for example RGB components. This |
| | | means, for example, that the map can display the |
| | | diffraction efficiency resolved for the plurality of |
| | | components of the light that correspond to different |
| | | wavelengths; and then an adjustment of the intensity of the |
| | | light is also effected resolved for the different |
| | | components. |
| | | If the laser spot or light point 42 stays e.g. in the region |
| | | 703 (beam 783) and the diffraction efficiency of the |
| | | master HOE is there (as an example) significantly |
| | | greater (about 0.8) in the red wavelength range than in |
| | | the blue and green (about 0.6) wavelength range, this |
| | | can be compensated for by a higher intensity for the |
| | | blue component and the green component compared |
| | | with the red component of the light. |
| | | Different intensities can be set for the regions 701 and |
| | | 702. For example, it would be conceivable that the |
| | | diffraction efficiency for all components of the light is 0.8 |
| | | in the region 702, with the result that no relative |
| | | adjustment of the intensity for the different components has |
| | | to be made. In the region 701, the diffraction efficiency |
| | | for the blue component could be 0.4 and for the red |
| | | component and the green component it could be 0.6. |
| | | In such a case, a particularly high intensity for the blue |
| | | component could be used to compensate for the reduced |
| | | diffraction efficiency (and thus the reduced replication |
| | | efficiency, see TAB. 1: Example II); an intensity |
| | | that is high in absolute terms but is reduced in relation |
| | | to the intensity used for the blue component, could be |
| | | used for the red and green components. In this way, in |
| | | particular, the colour ratios of the HOE to the master |
| | | HOE can be adjusted. |
| II | Exposure configuration | In some examples, an exposure configuration file can |
| | file | be obtained that describes the movement of the beam |
| | | path in relation to the surface of the carrier layer of the |
| | | master HOE during the exposure process. This means |
| | | that it is possible to specify how the position of the light |
| | | point 42 changes during the exposure process as a |
| | | function of time. For example, a corresponding scan |
| | | trajectory 791 (see FIG. 5) could be specified. |
| | | Alternatively or additionally, the path curve 61 (see FIG. |
| | | 2) could also be shown. Alternatively or additionally, the |
| | | angle of incidence 89 could also be shown. Generally |
| | | speaking, the exposure configuration data can |
| | | describe the change in the angle of incidence 89 of the |
| | | beam path 41 in relation to the surface of the carrier |
| | | layer of the master HOE 96. |
| | | The control data can then be generated based on the |
| | | exposure configuration data. Such a determination |
| | | may take into account various aspects: For example, it |
| | | can be ensured in this way that synchronized control of |
| | | the adjustable optical element and of the beam movement |
| | | unit is effected; that is to say that, for example, it |
| | | is ensured that a different ratio of the intensities of the |
| | | components of the light is set depending on the position |
| | | of the light point 42. Optionally, it would also be |
| | | conceivable, based on the exposure configuration data, to |
| | | compensate for different replication efficiencies due to |
| | | the variation in the angle of incidence; see TAB. 2: |
| | | Example II or TAB. 1: Example III. This means that the |
| | | control data cause a rotation of the polarization plane, |
| | | for example to maintain the s-polarization or p- |
| | | polarization, during the change of the angle of incidence of |
| | | the beam path. |
| III | Target specification for | Examples of how compensation for an otherwise variable |
| | diffraction efficiency | replication efficiency is effected based on (e.g. |
| | | imperfect) structural properties of the master HOE |
| | | (Example I) or on properties of the exposure process |
| | | (Example II) have been described above. |
| | | However, it is also possible to implement a target |
| | | specification for the diffraction efficiency of the replicated |
| | | HOE by changing the intensity and/or the polarization. |
| | | This means that the control data can be generated |
| | | based on a corresponding target specification, which is |
| | | obtained in box 3805. For example, this target specification |
| | | may indicate a desired local variation in the diffraction |
| | | efficiency for the replicated HOE relative to a |
| | | measured local variation in the diffraction efficiency of |
| | | the master HOE. For example, if the diffraction efficiency |
| | | of the master HOE varies by 10% in a specific |
| | | region, the diffraction efficiency of the HOE tends to |
| | | vary accordingly (see TAB. 1: Example II); the target |
| | | specification can indicate that the diffraction efficiency |
| | | of the HOE should fluctuate by a factor of 2 less than |
| | | the diffraction efficiency of the master HOE, for example. |
| | | This can be done, for example, resolved for different |
| | | components of the light that correspond to different |
| | | wavelengths. Thus, if the master HOE has a particular |
| | | diffraction efficiency, the diffraction efficiency of the |
| | | replicated HOE can be determined as deviating from |
| | | that diffraction efficiency. This can be achieved by |
| | | selectively increasing or decreasing the dose of the |
| | | exposure by increasing or decreasing the intensity. |

TAB. 4: Various examples of input data that can be used to generate control data for an adjustable optical element. The various examples can also be combined.

As a general rule, the control data in box 3810 can be determined in different phases. This is described in connection with TAB. 5.

| | EXAMPLE | EXEMPLARY DETAILS |
|---|---|---|
| I | During production of | For example, the control data can be determined in |
| | master HOE | connection with the production of the master HOE. For |
| | | example, the control data in box 3810 could be determined |
| | | in connection with box 3005 of the method in |
| | | FIG. 1. The control data can therefore be determined, |
| | | for example, by a manufacturer of the master HOE. |
| | | For this purpose, for example, it is possible to acquire |
| | | measurement data for the master HOE after its production |
| | | which are indicative of the diffraction efficiency, so |
| | | that based on this, the efficiency map (see TAB. 4: |
| | | Example I) can be determined. Such a variation in the |
| | | diffraction efficiency for example due to variations in |
| | | structural properties of the master HOE - see TAB. 2: |
| | | Scenario I - can then be compensated for by appropriately |
| | | configuring the control data. |
| II | Prior exposure process | For example, prior to the production of the HOE by |
| | | replicating the master HOE. For example, it could be |
| | | determined which exposure surface shape 912 the |
| | | master HOE will have during replication (see FIG. 1: box |
| | | 3010). This can depend, for example, on whether it is |
| | | being replicated in a flatbed or a roll-to-roll process. |
| | | This may vary depending on the exposure apparatus. |
| | | It would also be possible to check different target |
| | | geometries for the replicated HOE, for example, depending |
| | | on the application. This means that the surface |
| | | shape 911 can vary. Based on this surface shape 912 |
| | | and/or the surface shape 911, the path curve 61 and |
| | | thus the angle of incidence 89 could then be determined. |
| | | To compensate for different replication efficiencies |
| | | due to the varying angles of incidence 89 (and thus |
| | | the different orientations of the polarization of the light |
| | | in relation to the surface of the carrier material of the |
| | | master HOE; see TAB. 2: Scenario II), it is then possible |
| | | to determine a change in the polarization of the light |
| | | by way of the control data.: For example, the s-polarization |
| | | can be used for the replication, and the reflection |
| | | losses can be compensated for by varying the intensity. |
| | | Other scenarios from TAB. 2 can also be applied. |
| III | In-line with production | It is also possible that in-line measurement data |
| | | collected in connection with the production of the HOE |
| | | may be taken into account. The control data can then |
| | | be determined based on these in-line measurement |
| | | data. |
| | | This means therefore that the production of the HOE |
| | | by replicating the master HOE can be monitored, for |
| | | example, by producing a test instance of the HOE by |
| | | replicating the master HOE and then measuring it for |
| | | production. The spatially resolved diffraction efficiency |
| | | of these test instances could then be determined. |
| | | Based on this, for example, a map of the replication |
| | | efficiency or the diffraction efficiency of the master HOE |
| | | could be determined. |
| | | This means therefore that the result of the production |
| | | process for the replicated HOE can be monitored (in- |
| | | line quality monitoring) and then unwanted effects can |
| | | be compensated, in-line, by adapting the change in the |
| | | intensity and/or the polarization over time during the |
| | | exposure process. |

TAB. 5: Various variants for phases in which the control data can be generated for a tailored diffraction efficiency of the replicated HOE. Such variants can also be combined. In particular, a distinction can be made between a case in which the manufacturer of the master HOE takes measurements to characterize the master HOE in order to generate in this way control data which are, for example, supplied together with the master HOE (see Example I from TAB. 5), and a case in which the control data are generated after the master HOE has been delivered to a user prior to or together with the production of the replicated HOE (see Examples II and Ill from TAB. 5). These cases can also be combined with one another, for example, to address different scenarios according to TAB. 2.

Using the techniques described in FIG. 4, it is possible to generate the control data in an optimized manner; for example, if in the case of a poor master HOE and resulting poor interference contrasts, too high a dose is used in the exposure (due to selecting too high an intensity or an incorrect change in the polarization), the reverse effect and a drop in the diffraction efficiency in the replicated HOE can occur locally, because the refractive-index modulation of the material is “exposed out” again. This can be avoided by appropriately determining the control data.

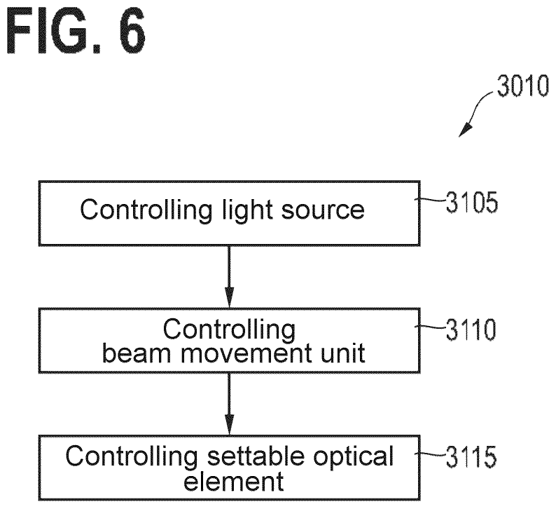

Once the control data have been determined, the HOE can then be exposed by replicating the master HOE. This is disclosed in connection with FIG. 6.

FIG. 6 illustrates an exemplary method. The method in FIG. 6 is used to produce a replicated HOE. In particular, the method in FIG. 6 relates to the replication process, see FIG. 1: box 3010. By way of example, the method from FIG. 6 can be implemented by a controller, for example, by the controller 51 of the system 50 from FIG. 2. For example, the processor could load and execute program code 191 from the memory 192 to carry out the method from FIG. 6.

In box 3105, a light source, such as a laser, is controlled to emit light along a beam path to a master HOE. For example, the light source could be controlled in such a way that it continuously emits light at a specific light intensity during an exposure process. The light source could also be switched on and off in alternation. This can be helpful, for example, when a step mode for moving the beam path on the surface of the carrier layer is effected, that is to say, in the example, moving the light point between two different positions or two scan lines.

In box 3110, a beam movement unit (see beam movement unit 55) can be controlled to move a beam path in relation to the surface of the carrier layer of the master HOE. For example, the angle of incidence together with the position could be changed when a scan line is travelled by a scanning mirror. A more complex movement could also occur, where a reference point is moved along a curved trajectory. For this purpose, a robot arm could be controlled, for example.

In box 3115, the adjustable optical element can be controlled to change the intensity and/or the polarization of the light. For example, the intensity and/or the polarization may be changed between two finite values of >0. There could be a stepped change, whenever the light source is switched off and/or the beam path is moved or has been moved, see box 3105. Boxes 3105, 3110 and 3115 can therefore be performed synchronously.

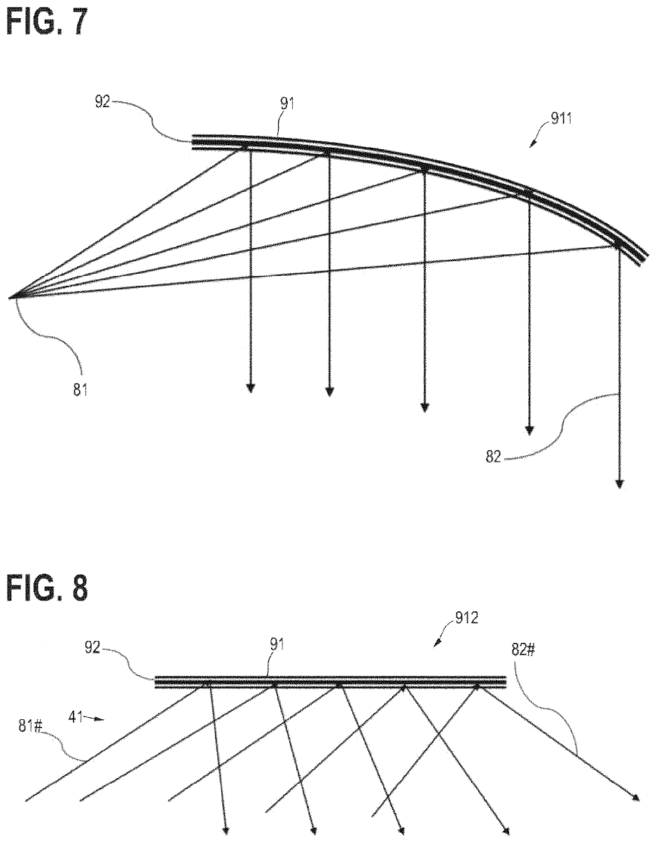

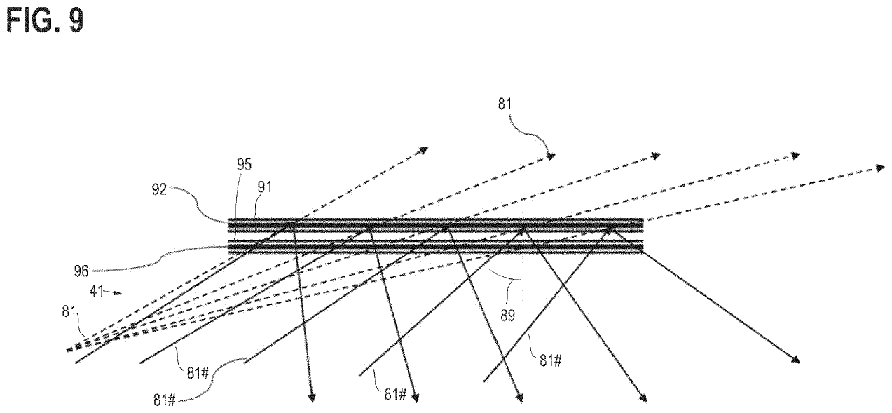

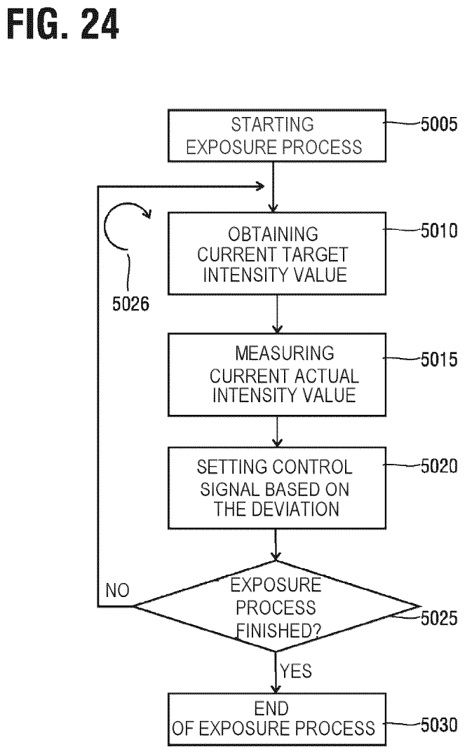

To set the intensity, it would be conceivable that a target specification for the intensity that is taken into account in connection with a control loop is adapted. However, it is not necessary to use a control loop in all variants: a change in intensity which is not controlled by a control loop is also conceivable. Aspects in connection with a variant with a control loop will be described below in connection with FIG. 24. Aspects related to the beam movement unit are explained below. In some examples, the beam movement unit can generate a curved path curve 61 for the reference point 84 (see FIG. 2; box 3110). The curved path curve 61 can be different depending on the master HOE 92. This changes in particular the angle of incidence 89, but also, for example the position of the light point on the surface of the carrier material of the master HOE. This dependency of the curved path curves 61 on the master HOE used stems from the fact that, depending on the master HOE 92, different target surface shapes 911 can be used (wherein the exposure process for replication can take place in each case in the same exposure surface shape 912 because this exposure surface shape 912 is dictated by the replication process used). Accordingly, a different compensation is achieved by the curved path curve 61. This is described below in connection with FIG. 7, FIG. 8 and FIG. 9.

FIG. 7 illustrates aspects relating to the target surface shape 911. FIG. 7 illustrates the master HOE 92 on the corresponding carrier layer 91, which has the target surface shape 91.

In the example of FIG. 7, the master HOE 92 implements an optical functionality of an off-axis paraboloid mirror illuminated by a point light source. An incident divergent beam 81 is converted to a parallel beam 82. This is only an exemplary optical functionality, and a broad spectrum of different optical functionalities is conceivable in principle.

In any case, the replicated HOE 96 should implement the corresponding optical functionality if the replicated HOE 96 has the same target surface shape 911.

During the exposure of the replicated HOE 96 (see FIG. 1: box 3010), however, the replicated HOE 96 and the master HOE 92 have the exposure surface shape 912. This is shown in FIG. 8.

The transformation between the target surface shape 911 and the exposure surface shape 912 causes a change in the diffraction structure of the master HOE 92; this change in the diffraction structure can be correspondingly translated into a change in the rays of the incident beam 81 # and the rays of the reflected beam 82 #: These beams 81 # and 82 # are “drawn” in the drawing plane, just like the diffraction structure.

Various examples are based on the finding that for the production of the replicated HOE 96 when using the exposure surface shape 912, the beam path 41 of the light used for the exposure should simulate the rays of the adapted beam 81 #(see FIG. 8) in order to ensure in this way the optical functionality of the replicated HOE 96 according to FIG. 7 (shown there for the master HOE 92) if the target surface shape 911 is present. This is shown in FIG. 9.

FIG. 9 illustrates aspects related to a flatbed replication process for replicating the master HOE 92, for exposing the replicated HOE 96. FIG. 9 shows that the carrier layer 91 of the master HOE 92 extends parallel to the carrier layer 95 of the replicated HOE 96 during the exposure of the replicated HOE 96. To expose the replicated HOE 96, the master HOE 92 is illuminated with light along rays 81 #; it is evident from FIG. 9 that the angle of incidence 89 of these rays 81 # varies as a function of the position of the corresponding light point on the master HOE 92, which is achieved by using the curved path curve 61 of the reference point 84 along the beam path 41 and optionally by changing the exit angle of the light from the reference point 84 (for example, by using a scanning mirror). If the replicated HOE 96 is then in use and has the target surface shape 911, illumination with other beams (shown in FIG. 9 by the dashed arrows) can take place, as already described above in conjunction with FIGS. 7 and 8.

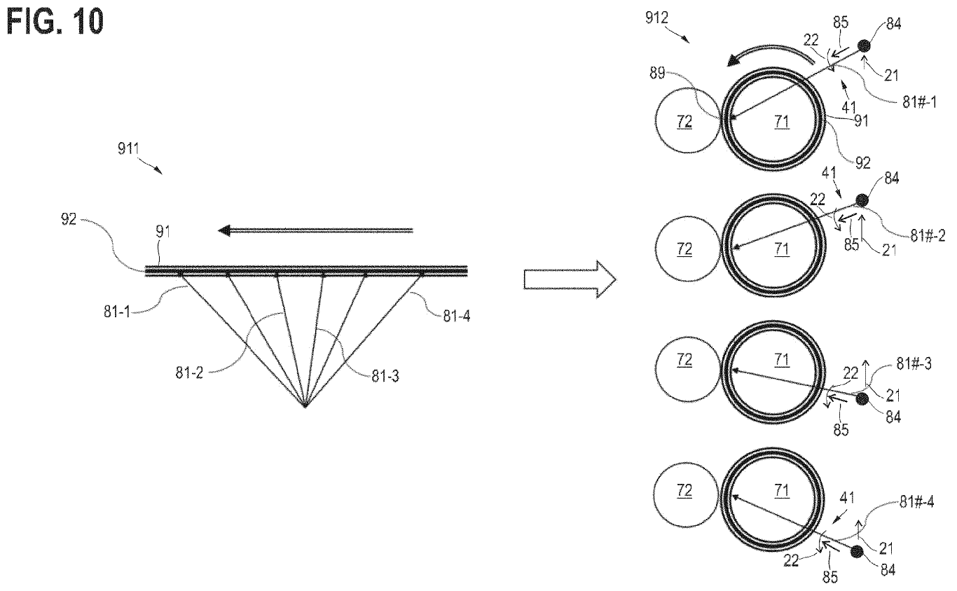

FIG. 10 illustrates aspects related to a roll-to-roll replication process for replicating the master HOE 92, that is to say, for exposing the replicated HOE 96. FIG. 10 shows on the left a section through the master HOE 92 if the latter has the target surface shape 911, i.e. when it is being produced (see box 3005 in FIG. 1). In addition, the corresponding rays 81-1-81-4 of a beam which is used for the exposure are shown, which is used later, when using the replicated HOE 96, for the illumination of the replicated HOE 96.

In the roll-to-roll replication process (see box 3010 in FIG. 1), the master HOE 92 is applied to a roll 71 and the corresponding rays 81 #-1-81 #-4 of the beam path 41 of the light which are used to illuminate the master HOE 92 are achieved with increasing rotation of the roll 71 by a movement 21 of the reference point 84 and a correspondingly modified exit angle 85 of the light from the reference point 84 (e.g. achieved by tilting 22 a corresponding mirror arranged in the reference point 84). Thus, during the exposure process of the replicated HOE (which is applied to another roll 72 and is not shown in FIG. 10 for reasons of clarity), the curvature of the carrier material 91 of the master HOE 92 is compensated for by the curved path curve.

Techniques related to the movement of the reference point 84 have been explained above. It has also been explained how the exit angle 89 can be changed. It is optionally possible to synchronize the movement of the reference point 84 along the curved path curve 61 with a scanning of the light beam 41. In contrast to a change in the exit angle 89, as discussed above, the scanning of the light beam 41 can be implemented by a periodic scanning movement.

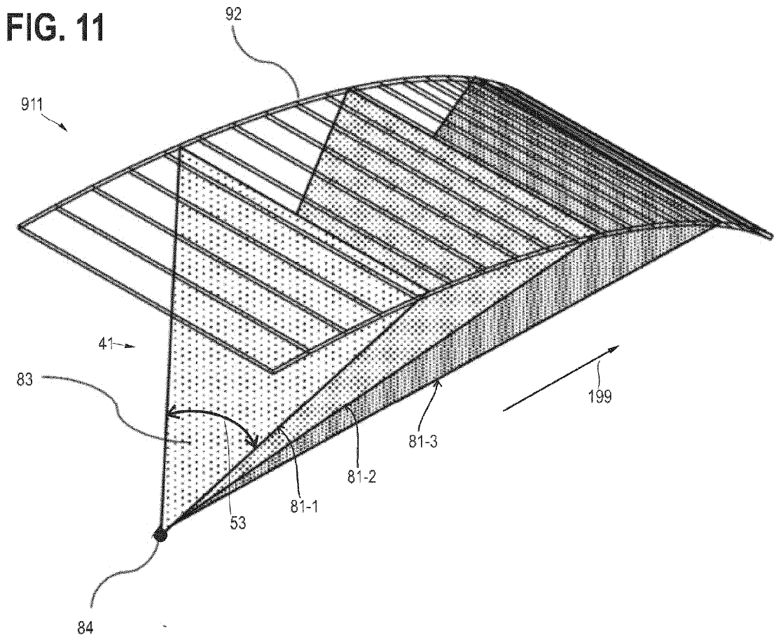

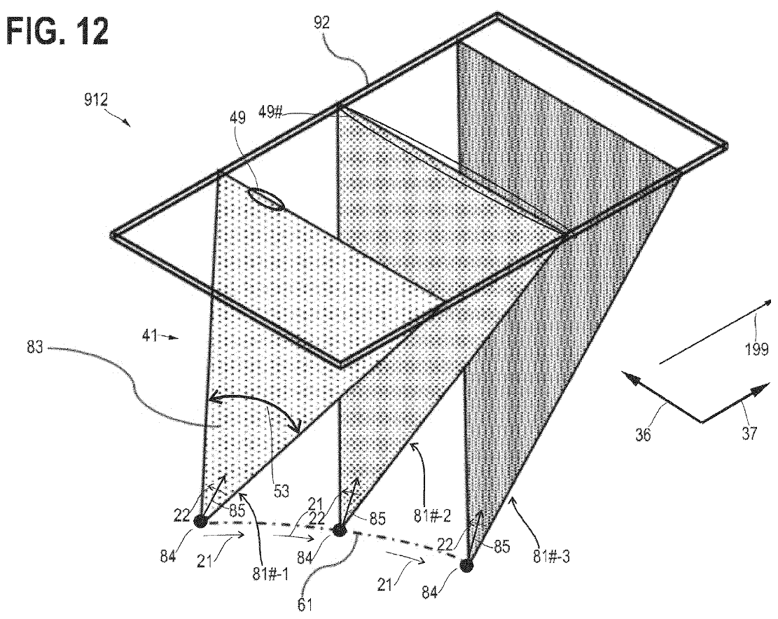

For example, the reference point 84 could mark a midpoint of the scanning movement 53. Aspects relating to the scanning are illustrated below in connection with FIG. 11 and FIG. 12.

FIG. 11 shows a master HOE 92, which implements the optical functionality of an off-axis parabolic mirror as an example. FIG. 11 shows the master HOE 92 in the target surface shape 911; FIG. 12 shows the same master HOE 92 in the exposure surface shape 912. It is evident from FIG. 11 that the master HOE 92 in the target surface shape 911 has a one-dimensional curvature along an axis of curvature 199.

This means that it is possible to mediate between the target surface shape 911 and the exposure surface shape 912 by way of a one-dimensional curvature operation along the axis of curvature 199 (a curvature perpendicular to the axis of curvature 199 is not changed). The same applies (in inverse form) to the example of FIG. 8. Generally speaking, a transition between a one-dimensional curvature of the carrier layer 91 of the master HOE and a planar configuration of the carrier layer 91 of the master HOE 92 takes place.

The scanning direction 36 of the scanning movement 53 of a scanned light point 49 on the master HOE 92 by means of the scanning mirror is oriented perpendicular to the axis of curvature 199, see FIG. 12. This is due to the fact that no displacement of the origin of the scanning movement 53 needs to occur perpendicular to the axis of curvature 199 because there is no transformation of the curvature of the corresponding surface in this direction 36.

The example in FIG. 12 thus corresponds to a line scanner.

Overlaid with the scanning movement 53 along the scanning direction 36, the movement of the reference point 84 takes place along the curved path curve 61. This shifts the light point 49 along the direction 37. The corresponding movement 21 has a component along an axis 37 that is oriented perpendicular to the scanning direction 36 (and thus parallel to the axis of curvature 199) along the direction 37.

FIG. 12 also shows the (non-scanned) change in the exit angle 85 by way of a corresponding control of the beam movement unit. In some examples, a two-dimensional scanning mirror could be used to implement both scanning (i.e. a periodic movement around a scan centre) along the scanning direction 36 and also the non-scanned change in the exit angle 85, for example, by way of a corresponding tilt 22 in the reference point 84. A similar scenario has been discussed in connection with FIG. 2; the scanning mirror can then be arranged in the reference point 84.

In the example in FIG. 12, the scanning could be effected with a fixed scanning frequency of a fixed scanning amplitude, with the result that the entire region between the two edges of the master HOE 92 is swept over by the light point 49. In such an example, in particular a resonantly driven scanning mirror could be used.

Not all examples require the implementation of the scanning movement 53. For example, at least one optical element could also be arranged in the reference point 84, which optical element causes the light point 49 # of the light on the master HOE 92 to be expanded along the direction 36 (compare light point 49 with light point 49 #). The otherwise scanned lines are then exposed in an integrated manner.

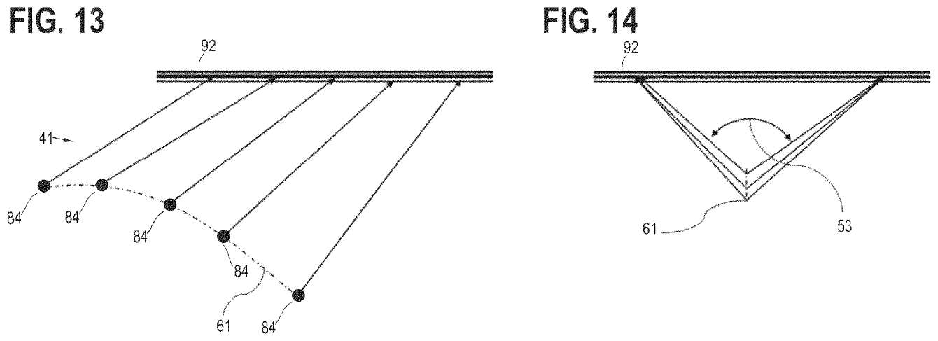

FIG. 13 and FIG. 14 are side views from mutually perpendicular perspectives for the scenario in FIG. 10.

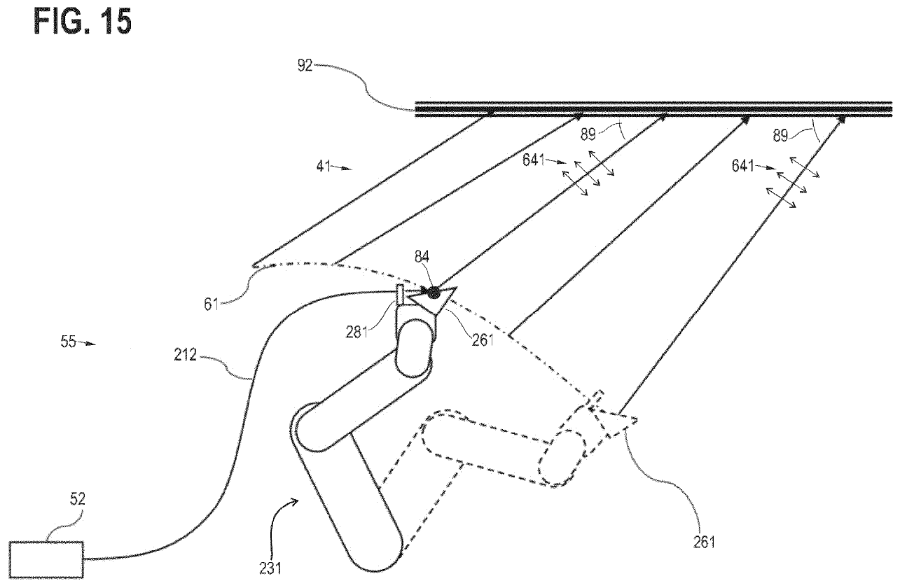

FIG. 15 shows an exemplary implementation of the beam movement unit 55. The beam movement unit 55 comprises a robot arm 231. An optical fibre 212 guides the light from the laser 52 to the moving end of the robot arm 231. There, the light is coupled out by an output coupling unit 281, which may comprise, for example, a corresponding lens element (GRIN lens) etc. The output coupling unit 281 can be designed to maintain polarization. In addition, a two-dimensional galvo scanner 261 is arranged at the moving end of the robot arm 231; it implements both the tilt 22 for a non-scanning change of the exit angle 85 with which the light leaves the reference point 84; as well as the scanning movement.

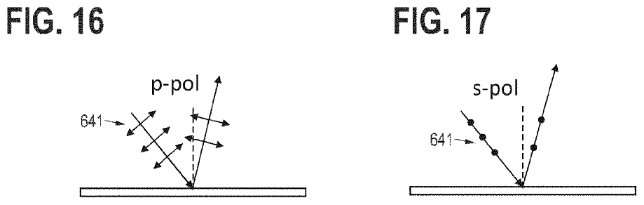

FIG. 15 also shows how the angle of incidence 89 can change during the exposure process because the beam path 41 is moved by the beam movement unit 55 over the surface of the carrier layer of the master HOE. As a result, the orientation of the polarization 641 of the light in relation to the surface of the carrier layer of the master HOE 92 may change. For example, a p-polarization could occur instead of an s-polarization, see FIG. 16 and FIG. 17 (if the beam path is rotated about an axis of rotation that does not coincide with the polarization direction, the angle of the polarization direction changes in relation to the surface normal of the surface of the carrier layer of the master HOE). This would influence the replication efficiency and can be compensated for by adapting the polarization and/or the intensity as described above.

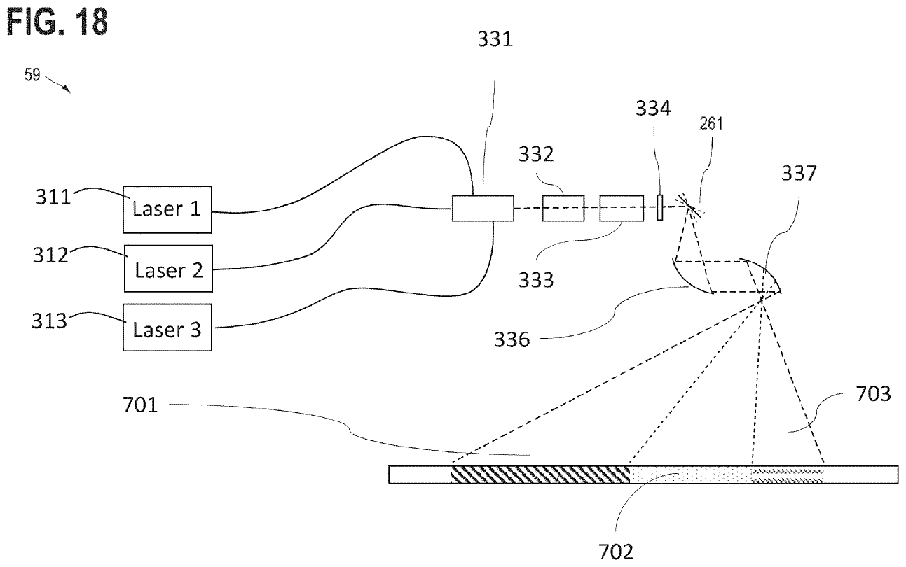

FIG. 18 schematically illustrates the exposure apparatus 59 according to various examples. The exposure apparatus 59 comprises in the example shown a plurality of lasers 311-313 for different wavelength components of the light. The lasers 311-313 implement a multi-colour light source. Corresponding components of the light are guided via optical waveguides to a beam-combining element 331, which then merges the corresponding partial beam paths.

An AOTF 332 which implements an adjustable optical element is then arranged in the beam path beam downstream of the beam-combining element 331. In addition, a Pockels cell 333 is arranged, which also implements an adjustable optical element. This allows adaptation of the intensity or the polarization of the light. A wave plate 334 is also provided and then the scanning mirror 261 and deflection mirrors 336, 337. (For example, a robot arm, if used, is not illustrated in FIG. 17).

The AOTF 332 filters light using sound waves. This is effected by the process of acousto-optical interaction in a suitable medium, often a crystal. When a sound wave propagates through the crystal, it causes periodic density changes in the material. These density changes result in a periodic change in the refractive index of the medium. When light passes through the crystal with the periodically changed refractive indices, it is diffracted, similar to light passing through a grating. Several components of the light are formed; these correspond to the different orders of diffraction, in particular the zero order of diffraction and the first order of diffraction. Typically, only the first order of diffraction is used to replicate the master HOE.

Instead of a single Pockels cell 333 as shown in the example of FIG. 18, it would be conceivable to provide a plurality of Pockels cells, for example one for each beam path between the beam-combining element 331 and the light sources 311-313. The polarization can then be adjusted separately for the different wavelength components of the light.

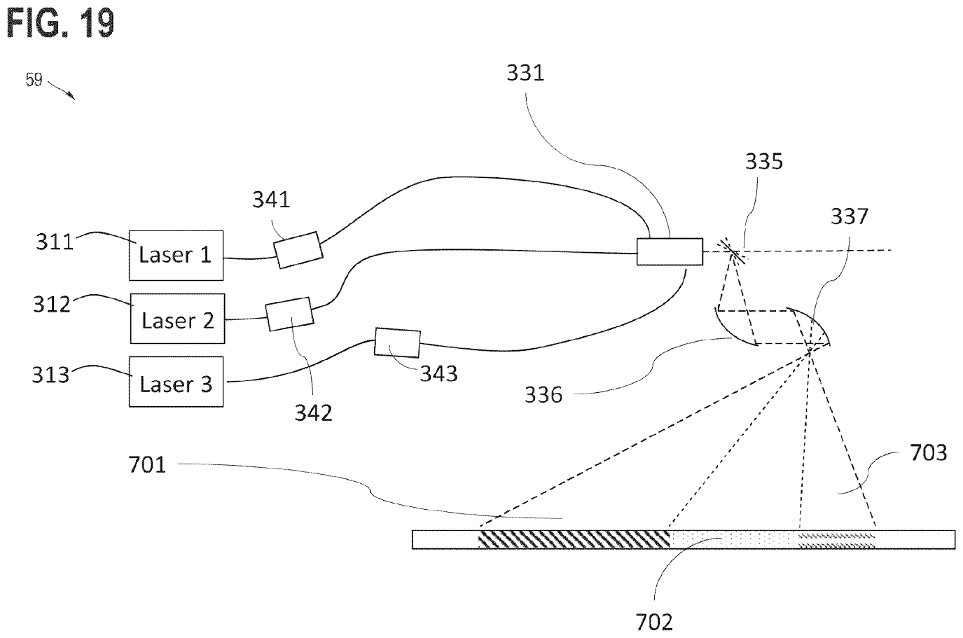

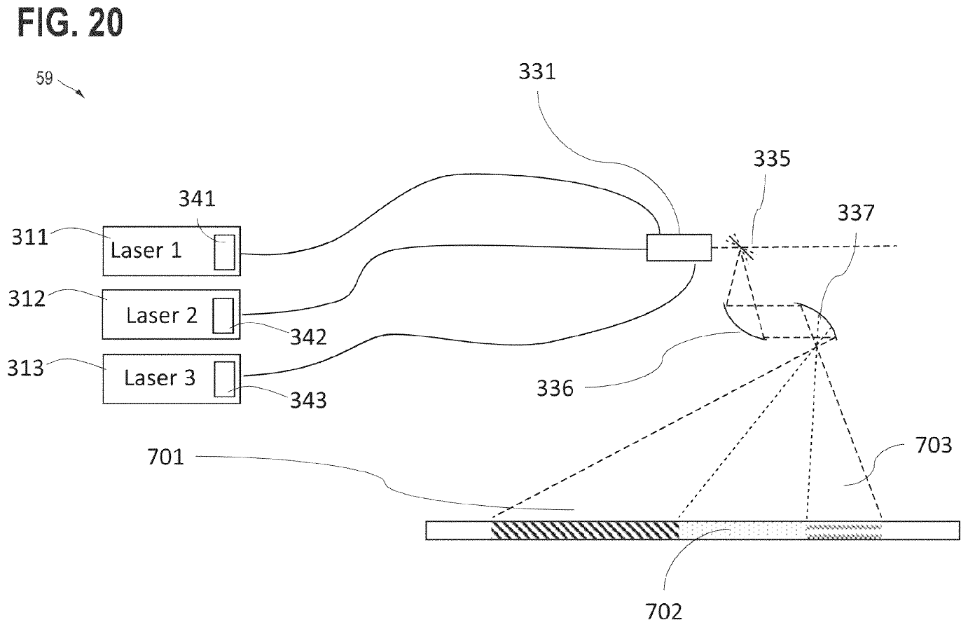

FIG. 19 shows a variation in the exposure apparatus 59 from FIG. 18. AOMs 341, 342, 343 are now used instead of the AOTF 332. These are arranged upstream of the beam-combining element 331 and are assigned in each case to the lasers 311-313 (in FIG. 20, the AOMs 341, 342, 343 are integrated into the lasers 311-313).

Although FIG. 19 and FIG. 20 do not show a Pockels cell, a Pockels cell could also be used.

Aspects in connection with power monitoring will be described below. Power monitoring can be used to ensure that the intensity of the light during the exposure process corresponds to a specification. The intensity of the light can be changed according to a time-variable target value. It is possible to control the light intensity in a control loop.

In order to ensure a correct setting of the intensity of the light, the intensity of the light can be checked during the replication process/exposure process.

Various examples are based on the finding that a measurement of the used beam is not easy during the running exposure process: Conventional sensors block the beam during the measurement. There are a number of variants to still enable a measurement of the light intensity.

In one variant, some of the power of the used beam is redirected by means of a beam splitter, e.g. a 90:10 beam splitter, or by means of another optical unit, and used for measurement. A corresponding sensor (see FIG. 1: sensor 57) is then arranged in the redirected partial beam. However, this will result in a loss of power from the used beam.

It may be desirable to indirectly measure the intensity of the used beam. This avoids reducing the power of the used beam (that is, the component of the light that is used to replicate the master HOE). Such variants are shown below.

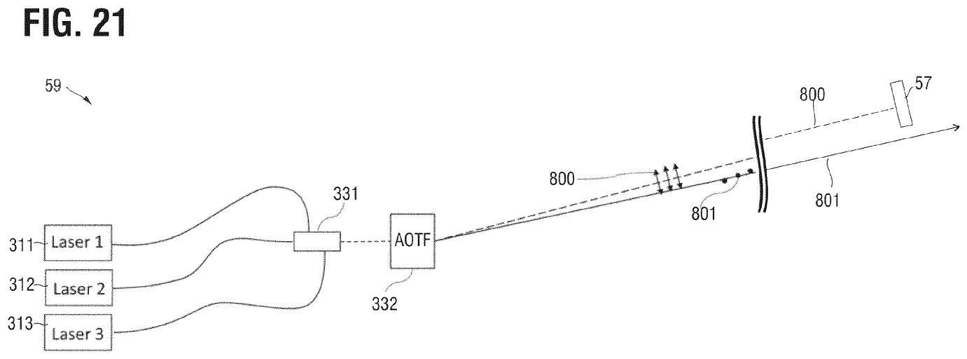

A variant of the exposure apparatus 59 is shown in FIG. 21. FIG. 21 corresponds, in principle, to FIG. 18 (elements already explained in relation to FIG. 18 will not be explained again). In the case of the AOTF 332, the incident superposed beams are split into a zero order of diffraction 800 and a first order of diffraction 801 (the reference signs 800, 801 indicate the relevant beam paths). The first order of diffraction 801 is the set desired power, and the remaining power is in the zero order of diffraction 800. Depending on the type and design, the AOTF 332 can be configured in such a way that, for example, the first order of diffraction 801 (i.e. the used beam) is dispersion-corrected. That is, all wavelengths of the first order of diffraction 801 exit from the AOTF 332 at the same angle. The zero order of diffraction 800 contains the residual power, wherein the angles of the wavelengths differ slightly. A further property of the filters is the polarization state of the two orders of diffraction 800, 801, which are 90° linearly polarized to each other. In the example of FIG. 21, the first order of diffraction 801 is p-polarized with respect to the window, while the zero order is s-polarized.

One way to monitor the power without interfering with the used beam—i.e. the first diffraction order 801—is to measure the light of the zero order of diffraction 800 during the exposure process. Since the zero order of diffraction 800 lacks the power in the first order of diffraction 801, there is an inversely proportional relationship between the used power and the measurement value of the sensor 57 of the zero order of diffraction 800. By adjusting (calibrating) the two orders of diffraction 800, 801, the first order of diffraction 801 can thus be controlled in a control loop based on the measurement of the zero order of diffraction 800. Thus, an indirect measurement of the intensity of the used beam (first order of diffraction 801) is used.

However, due to the small angle difference between the zero order of diffraction 800 and the first order of diffraction 801 (of possibly a few degrees), a long beam path is required to sufficiently separate the beams. That is shown in FIG. 21, where the sensor 57 is located at a large distance from the AOTF 332, so that the light of the first order of diffraction 801 can travel past the sensor 57.

FIG. 21 does not show further optical elements (which are located downstream in the beam path of the light of the first order of diffraction 801), such as a Pockels cell or a deflection mirror (see FIG. 18: Pockels cell 333, deflection mirror 261, etc.). The various further optical elements may be designed according to the various variants described herein.

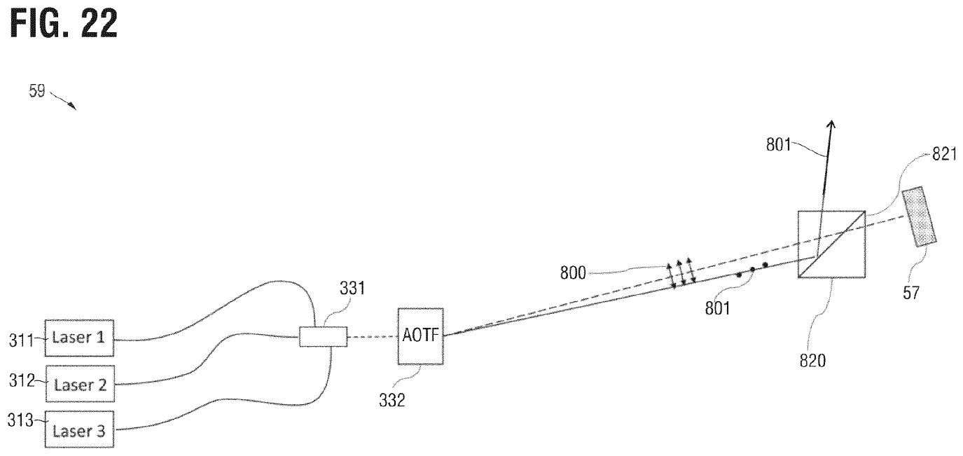

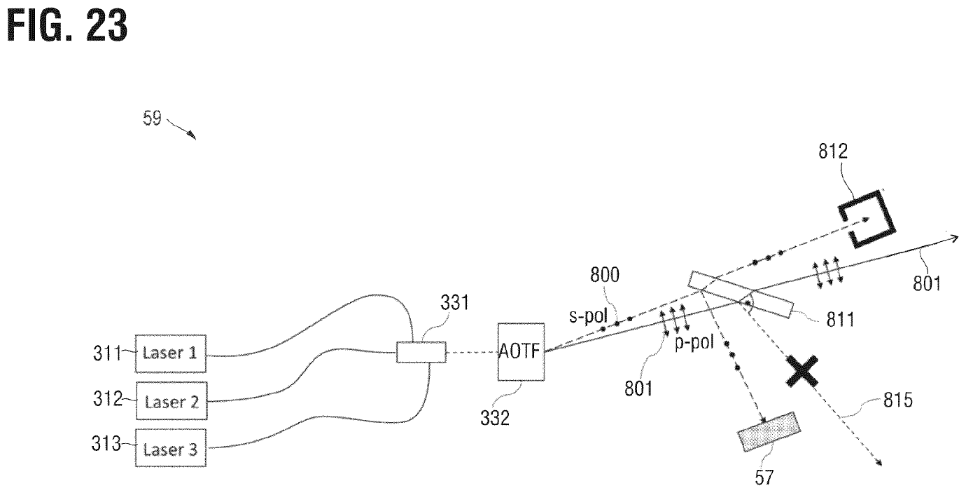

A more compact variant than in FIG. 21 with the sensor 57 of the exposure apparatus 59 is shown in FIG. 22. FIG. 22 here basically corresponds to FIG. 21. In FIG. 22, a polarizing beam splitter 820 is located along the beam path of the light downstream of the AOTF 332. The AOTF 332 is oriented in such a way that the first order of diffraction 801 is perpendicularly polarized. The light of the first order of diffraction 801 is thereby deflected and coupled into the remaining optical system (as is not shown in FIG. 21, but is configurable variably according to the rest of the disclosure), whereas the zero order of diffraction 800 passes straight through the polarizing beam splitter 820 onto a power measurement head of the sensor 57. The intensity of the light of the first order of diffraction can therefore be ascertained during the exposure process without intervention in the first order of diffraction 801 by measuring the intensity of the light of the zero order of diffraction 800 (i.e. again an indirect measurement). The disadvantage of this variant of FIG. 22 occurs at particularly high laser powers e.g. of greater than a few 100 mW: It may be necessary to use a sensor 57 that determines the intensity thermally; the measurement frequency is then very low. Under certain circumstances, a neutral density filter or the like may be used, which either lead to back-reflections or might be destroyed in the case of absorptive filters. In order to alleviate or eliminate these disadvantages, the variant in FIG. 23 can be used.

The variant of FIG. 23 corresponds in principle to the variant of FIG. 21 or the variant of FIG. 22.

Along the beam path of the light downstream of the AOTF 332, an optical plate 811 (i.e. a window made of e.g. BK7, quartz glass, etc.) is positioned at an angle such that the first order of diffraction 801 is incident on the optical plate p-polarized at the Brewster's angle (approx. 57° for BK7). This causes the first order of diffraction to pass through the window almost without any reflection losses (this is indicated by the crossed-out reflection ray 815). The zero order of diffraction 800, on the other hand, has no Brewster's effect due to its polarization and the changed angle and is reflected according to the usual Fresnel equations. The approx. 5-15% reflection can be detected with the sensor 57, as it is only a fraction of the high laser power. Fast sensors are thus available. The remaining power passes through the window and can be safely steered to a dedicated beam trap/absorber 812. If necessary, the angle of the zero order of diffraction 800 and first order of diffraction 801 can be increased with respect to each other by way of a wedge-shaped design of the optical plate 811 in order to achieve a faster separation of the beams.

Several aspects in connection with an implementation of the adjustable element by means of AOTF 332 have been described above. However, it would also be conceivable that the adjustable element is implemented by means of an AOM. Here, too, various orders of diffraction occur, which can be used for replication and for the measurement of the intensity, as described above.

FIG. 24 illustrates a flowchart of an exemplary method. The method in FIG. 24 serves to control the light intensity during an exposure process which is used to replicate a master HOE. The method according to FIG. 24 can therefore be part of box 3010 according to FIG. 1.

By way of example, the method from FIG. 24 can be carried out by a controller. By way of example, the method from FIG. 24 can be realized by the controller 51 of FIG. 2. It is conceivable that the method from FIG. 24 is implemented partly in software and partly in hardware or only in software or only in hardware. For example, an implementation in hardware can be used if a particularly fast closed-loop control of the light intensity during the exposure process is desired.

The exposure process is started in box 5005. This means that a light source (see e.g. FIG. 2: light source 52) is controlled to emit light. A beam movement unit and/or at least one optical element can also be controlled. Corresponding aspects have been mentioned above in connection with the method according to FIG. 6.

A current target intensity value is received in box 5010. For example, the corresponding target intensity value for control data can be displayed. Several aspects in connection with control data 401 were described above.

In box 5015, the actual intensity value of the light used to replicate the master HOE is measured. For this purpose, appropriate measurement values can be obtained from a sensor, e.g. a photodiode. The sensor is preferably positioned near the HOE to be exposed. Aspects in connection with a corresponding sensor 57 were described above in connection with FIG. 2 and the variants of FIG. 21, FIG. 22 and FIG. 23.

In box 5020, a control signal can then be set based on a deviation between the target intensity value of the current iteration of box 5010 and the actual intensity value of the current iteration of box 5015. In particular, the control signal can be adjusted to reduce the deviation. For example, a PID controller can be used to ascertain the control signal. The control signal can be used in several ways to control the intensity. For example, a Pockels cell could be controlled. However, it is also possible, alternatively or additionally, that the light source itself is controlled. An AOTF could also be controlled (see FIG. 21, FIG. 22, FIG. 3: AOTF 332) or an AOM.

Box 5025 checks whether the exposure process is complete. If the exposure process is not yet complete, a further iteration 5026 is carried out. In a further iteration 5026 of box 5010, a further target intensity value is obtained, etc. When the exposure process in box 5025 is finished, the process in box 5030 is ended.

In summary, the following EXAMPLES, in particular, have been described:

EXAMPLE 1. Control apparatus (51) for an exposure apparatus (59) for producing a holographic optical element, HOE, (96) by replicating a master HOE (92) within the framework of an exposure process carried out by the exposure apparatus (59), wherein the exposure process uses light which is emitted from at least one light source (52) of the exposure apparatus during the exposure process along a beam path (41) to a surface of the carrier layer of the master HOE (92), wherein a carrier layer of the master HOE (92) is arranged along a carrier layer of the HOE (92) during the exposure process, wherein the control apparatus (51) comprises at least one processor (191) and a memory (192), wherein the at least one processor (191) is configured to load program code from the memory (192) and to execute the program code, wherein the at least one processor (191) is configured to perform the following steps based on the program code:
controlling a beam movement unit (55) of the exposure apparatus (59) such that it moves the beam path (41) during the exposure process in relation to the surface of the carrier layer of the master HOE (92), and
controlling at least one adjustable optical element (54) of the exposure apparatus (59), with the former being arranged in the beam path (41), so that the at least one adjustable optical element (54) during the exposure process changes at least one of an intensity and a polarization of the light over time.

EXAMPLE 2. Control apparatus (51) according to EXAMPLE 1, wherein the at least one processor (191) is further configured to perform the following step based on the program code:
loading control data (401) indicating a correlation between the movement of the beam path (41) in relation to the surface of the carrier layer and the change in at least one of the intensity and the polarization of the light,
wherein the control of the beam movement unit (55) and the control of the at least one adjustable optical element (54) are effected in synchronized fashion based on the control data (401).

EXAMPLE 3. Control apparatus (51) according to EXAMPLE 1 or 2,
wherein the at least one adjustable optical element (54) changes the intensity of the light,
wherein the at least one adjustable optical element (54) and the beam movement unit (55) are controlled in such a way that an influence of a variation of structural properties of the master HOE (92) on an efficiency of the replication of the master HOE is reduced by the change in the intensity of the light during the exposure process.

EXAMPLE 4. Control apparatus (51) according to EXAMPLE 3,
wherein the at least one adjustable optical element (54) and the beam movement unit are controlled in such a way that an influence of the variation of structural properties of the master HOE (92) on a diffraction efficiency of the master HOE is reduced by the change in the intensity of the light during the exposure process.

EXAMPLE 5. Control apparatus (51) according to any of the preceding EXAMPLES,
wherein the at least one adjustable optical element (54) changes the polarization of the light,
wherein the at least one adjustable optical element (54) and the beam movement unit (55) are controlled in such a way that an influence of the movement of the beam path (41) on a change in an orientation of the polarization of the light in relation to the surface of the carrier layer of the master HOE during the exposure process is reduced.

EXAMPLE 6. Control apparatus (51) according to any of the preceding EXAMPLES,
wherein the at least one adjustable optical element (54) changes the polarization of the light,
wherein the at least one adjustable optical element (54) is controlled in such a way that an influence of a variable angle of incidence of the beam path (41) due to the movement of the beam path (41) on a change in an efficiency of the replication during the exposure process is compensated for.

EXAMPLE 7. Control apparatus (51) according to any of the preceding EXAMPLES,
wherein the at least one wavelength comprises a plurality of wavelengths,
wherein the at least one adjustable optical element (54) is controlled such that it changes the intensity of components of the light that correspond to the plurality of wavelengths relative to one another during the exposure process.

EXAMPLE 8. Control apparatus (51) according to any of the preceding EXAMPLES,
wherein the beam movement unit (55) is controlled with a first signal bandwidth in the kilohertz range,
wherein the adjustable optical element (54) is controlled with a second signal bandwidth greater than the first signal bandwidth.

EXAMPLE 9. Control apparatus (51) according to any of the preceding EXAMPLES,
wherein the beam movement unit (55) is controlled to move the beam path in a step mode,
wherein the at least one adjustable optical element (54) is controlled to change the at least one of the intensity and polarization in connection with a step of the step mode.

EXAMPLE 10. Control apparatus (51) according to any of the preceding EXAMPLES,
wherein the control apparatus (51) is further configured to change the intensity of the light by means of a control loop over time during the exposure process.

EXAMPLE 11. System (50) comprising:
the control apparatus (51) according to any of the preceding EXAMPLES, and
the exposure apparatus (59).

EXAMPLE 12. System (50) according to EXAMPLE 11,
wherein the at least one adjustable optical element (54) comprises at least one acousto-optic modulator for changing the intensity of the light by adjusting a degree of transmission.

EXAMPLE 13. System (50) according to EXAMPLE 12,
wherein the at least one wavelength comprises a plurality of wavelengths,
   wherein the at least one adjustable optical element (54) each comprises an acousto-optic modulator for each of the plurality of wavelengths.

EXAMPLE 14. System (50) according to EXAMPLE 13,
wherein the control apparatus is further configured to
wherein the at least one light source (52) comprises a plurality of light sources for components of the light that correspond to the plurality of wavelengths,
wherein the exposure apparatus (59) further comprises a beam-combining element, which combines partial beam paths of the plurality of light sources for the components of the light that correspond to the plurality of wavelengths,
wherein the acousto-optic modulators are arranged, based on the beam-combining element, upstream along the partial beam paths.

EXAMPLE 15. System (50) according to any of EXAMPLES 11 to 14,
wherein the at least one adjustable optical element (54) comprises an acousto-optic multi-channel filter for changing the intensity of the light by adjusting a degree of transmission.

EXAMPLE 16. System (50) according to EXAMPLE 15,
wherein the at least one wavelength comprises a plurality of wavelengths,
wherein a filter curve of the acousto-optic filter can be adjusted individually for each of the plurality of wavelengths.

EXAMPLE 17. System (50) according to EXAMPLE 16,
wherein the at least one light source (52) comprises a plurality of light sources for components of the light that correspond to the plurality of wavelengths,
wherein the exposure apparatus (59) further comprises a beam-combining element, which combines partial beam paths of the plurality of light sources for the components of the light that correspond to the plurality of wavelengths,
wherein the acousto-optic filter is arranged, based on the beam-combining element, downstream along the partial beam paths.

EXAMPLE 18. System (50) according to any of EXAMPLES 11 to 17,
wherein the at least one adjustable optical element splits the light at least into a first component (800) and a second component (801),
wherein the system (50) comprises a sensor (57) which is configured to measure an intensity of the first component,
wherein the exposure apparatus (59) is configured to implement the exposure process with the second component.

EXAMPLE 19. System (50) according to EXAMPLE 18,
wherein the first component corresponds to an order of diffraction with a first polarization, wherein the second component corresponds to a further order of diffraction with a second polarization,
wherein the order of diffraction differs from the further order of diffraction,
wherein the first polarization optionally differs from the second polarization.

EXAMPLE 20. System (50) according to EXAMPLE 18 or 19, furthermore comprising:
a polarizing beam splitter (820) arranged in the beam path of the first component and in the beam path of the second component.

EXAMPLE 21. System (50) according to EXAMPLE 17 or 18, furthermore comprising:
an optical plate (811) arranged in the beam path of the first component (800) and in the beam path of the second component (801), wherein the optical is arranged tilted relative to the beam path of the second component (801) in such a way that it is incident on the optical plate at the Brewster's angle.

EXAMPLE 22. System (50) according to any of EXAMPLES 11 to 21,
wherein the at least one adjustable optical element (54) comprises a Pockels cell for changing the polarization by rotating a polarization plane.

EXAMPLE 23. System (50) according to any of EXAMPLES 11 to 22,
wherein the at least one adjustable optical element (54) comprises one or more lambda/2 plates, which can be introduced alternately into the beam path (41) by means of a motor.

EXAMPLE 24. Method for controlling an exposure apparatus (59) for producing a holographic optical element, HOE, (96) by replicating a master HOE (92) within the framework of an exposure process carried out by the exposure apparatus (59), wherein the exposure process uses light which is emitted from at least one light source (52) of the exposure apparatus during the exposure process along a beam path (41) to a surface of the carrier layer of the master HOE (92), wherein a carrier layer of the master HOE (92) is arranged along a carrier layer of the HOE (96) during the exposure process,
the method comprising the following steps:
controlling a beam movement unit (55) of the exposure apparatus (59) such that it moves the beam path (41) during the exposure process in relation to the surface of the carrier layer of the master HOE (92), and
controlling at least one adjustable optical element (54) of the exposure apparatus (59), with the former being arranged in the beam path (41), so that the at least adjustable optical element (54) during the exposure process changes at least one of an intensity and a polarization of the light over time.

EXAMPLE 25. Method according to EXAMPLE 24,
wherein at least the control of the at least one adjustable optical element (54) and/or the beam movement unit (55) is based on control data.

EXAMPLE 26. Method according to EXAMPLE 24 or 25,
wherein the at least one adjustable optical element (54) is controlled based on a closed control loop, which minimizes a deviation between a target intensity and an actual intensity of the light.

EXAMPLE 27. Method according to any of EXAMPLES 24 to 26,
wherein the method is carried out by the control apparatus (51) according to any of EXAMPLES 1 to 10.

EXAMPLE 28. Method for configuring a production method for producing a holographic optical element, HOE, by replicating a master HOE (92) within the framework of an exposure process carried out by an exposure apparatus (59), wherein a carrier layer of the master HOE (92) is arranged along a carrier layer of the HOE (96) during the exposure process,
wherein the method comprises the following step:
   generating (3810) control data (401) for at least one adjustable optical element (54) of the exposure apparatus (59), with the optical element being arranged in a beam path (41) of light used for the replication,
wherein the at least one adjustable optical element (54) can be controlled by means of the control data (401) such that it changes during the exposure process at least one of an intensity and a polarization of the light over time.

EXAMPLE 29. Method according to EXAMPLE 28, wherein the method furthermore comprises:
obtaining a map (799) of the master HOE (92), wherein the map (799) indicates a diffraction efficiency as a function of a position on a surface of the carrier layer of the master HOE (92),
   wherein the control data (401) are determined based on the map (799).

EXAMPLE 30. Method according to EXAMPLE 29,
wherein the control data (401) are determined using a predetermined transfer function based on the map (799),
wherein the predetermined transfer function assigns a comparatively higher intensity of the light to first regions (701, 702, 703) on the surface of the carrier layer having a comparatively low diffraction efficiency,
wherein the predetermined transfer function assigns a comparatively lower intensity of the light to second regions (701, 702, 703) on the surface of the carrier layer having a comparatively high diffraction efficiency.

EXAMPLE 31. Method according to any of EXAMPLES 28 to 30, wherein the method furthermore comprises:
obtaining exposure configuration data describing a movement of the beam path (41) during the exposure process in relation to the surface of the carrier layer of the master HOE (92),
wherein the control data (401) are generated based on the exposure configuration data.

EXAMPLE 32. Method according to EXAMPLE 31,
wherein the exposure configuration data describe a change in an angle of incidence of the beam path (41) during the exposure process in relation to the surface of the carrier layer of the master HOE (92),
wherein the control data (401) cause a rotation of a polarization plane to maintain an s-polarization or a p-polarization during the change of the angle of incidence of the beam path (41).

EXAMPLE 33. Method according to any of EXAMPLES 28 to 32, wherein the method furthermore comprises:
obtaining a target specification for a diffraction efficiency of the HOE (96),
wherein the control data (401) are generated based on the target specification for the diffraction efficiency of the HOE (96).

EXAMPLE 34. Method according to EXAMPLE 33,
wherein the target specification indicates a local variation in the diffraction efficiency of the HOE (96) relative to a local variation of a diffraction efficiency of the master HOE.

EXAMPLE 35. Method according to any of EXAMPLES 28 to 34, wherein the method furthermore comprises:
obtaining in-line measurement data collected in connection with the production of the HOE (96),
wherein the control data (401) are generated based on the in-line measurement data.

EXAMPLE 36. Method according to EXAMPLE 35,
wherein the in-line measurement data describe a diffraction efficiency of a test instance of the HOE (96).

EXAMPLE 37. Apparatus comprising at least one processor and a memory, wherein the at least one processor is configured to load program code from the memory and to execute the program code,
wherein the at least one processor is configured to carry out a method according to any of EXAMPLES 28 to 36 based on the program code.

It goes without saying that the features of the embodiments and aspects of the invention described above can be combined with one another. In particular, the features can be used not only in the combinations described but also in other combinations or on their own, without departing from the scope of the invention.

For example, techniques in which a change in the intensity of the light takes place via an adjustable optical element arranged in the beam path have been described above. Similarly, a light source, such as a laser, could also be controlled to change the intensity of the light. For example, a supply current for a laser diode could be reduced to reduce the intensity. In such variants, it may sometimes be unnecessary to provide a separate adjustable optical element in the beam path.

Further, techniques in which a change in the intensity of the light is effected via an adjustable optical element arranged in the beam path have been described above. This causes a change in the dose of the light used for the exposure. Alternatively, or in addition, the dwell time of the light point on the surface of the master HOE or the replicated HOE could be adapted to change the dose.

For example, techniques related to the implementation of a closed control loop for the intensity of light during the exposure process have been described above (see FIG. 24, for example). Alternatively, or in addition to such a closed control loop for the intensity of light, a closed control loop for the polarization of light can also be implemented.

While techniques have been described above by means of which it is possible to use a sensor value of the intensity or polarization for a closed control loop, it would also be possible to use corresponding sensor values for monitoring whether the sensor values are within a specified range. If they leave the tolerance range, the replication process can be aborted.

1. A control apparatus for an exposure apparatus for producing a holographic optical element, (HOE) by replicating a master HOE within the framework of an exposure process carried out by the exposure apparatus, wherein the exposure process uses light which is emitted from at least one light source of the exposure apparatus during the exposure process along a beam path to a surface of the carrier layer of the master HOE, wherein a carrier layer of the master HOE is arranged along a carrier layer of the HOE during the exposure process,
wherein the control apparatus comprises at least one processor and a memory, wherein the at least one processor is configured to load program code from the memory and to execute the program code, wherein the at least one processor is configured to perform the following steps based on the program code:
controlling a beam movement unit of the exposure apparatus such that it moves the beam path during the exposure process in relation to the surface of the carrier layer of the master HOE, and
controlling at least one adjustable optical element of the exposure apparatus, with the former being arranged in the beam path, so that the at least one adjustable optical element during the exposure process changes at least one of an intensity and a polarization of the light over time.

2. A control apparatus according to claim 1, wherein the at least one processor is further configured to perform the following step based on the program code:
loading control data indicating a correlation between the movement of the beam path in relation to the surface of the carrier layer and the change in at least one of the intensity and the polarization of the light,
wherein the control of the beam movement unit and the control of the at least one adjustable optical element are effected in synchronized fashion based on the control data.

3. The control apparatus according to claim 1,
wherein the at least one adjustable optical element changes the intensity of the light,
wherein the at least one adjustable optical element and the beam movement unit are controlled in such a way that an influence of a variation of structural properties of the master HOE on an efficiency of the replication of the master HOE is reduced by the change in the intensity of the light during the exposure process.

4. The control apparatus according to claim 3,
wherein the at least one adjustable element and the beam movement unit are controlled in such a way that an influence of the variation of structural properties of the master HOE on a diffraction efficiency of the master HOE is reduced by the change in the intensity of the light during the exposure process.

5. The control apparatus according to claim 1,
wherein the at least one adjustable optical element changes the polarization of the light,
wherein the at least one adjustable optical element and the beam movement unit are controlled in such a way that an influence of the movement of the beam path on a change in an orientation of the polarization of the light in relation to the surface of the carrier layer of the master HOE during the exposure process is reduced.

6. The control apparatus according to claim 1,
wherein the at least one adjustable optical element changes the polarization of the light,
wherein the at least one adjustable optical element is controlled in such a way that an influence of a variable angle of incidence of the beam path due to the movement of the beam path on a change in an efficiency of the replication during the exposure process is compensated for.

7. The control apparatus according to claim 1,
wherein the at least one wavelength comprises a plurality of wavelengths,
wherein the at least one adjustable optical element is controlled such that it changes the intensity of components of the light that correspond to the plurality of wavelengths relative to one another during the exposure process.

8. The control apparatus according to claim 1,
wherein the beam movement unit is controlled with a first signal bandwidth in the kilohertz range,
wherein the adjustable optical element; is controlled with a second signal bandwidth greater than the first signal bandwidth.

9. The control apparatus according to claim 1,
wherein the beam movement unit is controlled to move the beam path in a step mode,
wherein the at least one adjustable optical element is controlled to change the at least one of the intensity and polarization in connection with a step of the step mode.

10. The control apparatus according to claim 1,
wherein the control apparatus is further configured to change the intensity of the light by means of a control loop over time during the exposure process.

11. The system comprising:
the control apparatus according to claim 1, and
the exposure apparatus.

12. The system according to claim 11,
wherein the at least one adjustable optical element comprises at least one acousto-optic modulator for changing the intensity of the light by adjusting a degree of transmission.

13. The system according to claim 12, wherein the at least one wavelength comprises a plurality of wavelengths,
wherein the at least one adjustable optical element each comprises an acousto-optic modulator for each of the plurality of wavelengths.

14. The system according to claim 13,
wherein the control apparatus is further configured to
wherein the at least one light source comprises a plurality of light sources for components of the light that correspond to the plurality of wavelengths,
wherein the exposure apparatus further comprises a beam-combining element, which combines partial beam paths of the plurality of light sources for the components of the light that correspond to the plurality of wavelengths,
wherein the acousto-optic modulators are arranged, based on the beam-combining element, upstream along the partial beam paths.

15. The system according to claim 11,
wherein the at least one adjustable optical element comprises an acousto-optic multi-channel filter for changing the intensity of the light by adjusting a degree of transmission.

16. The system according to claim 15,
wherein the at least one wavelength comprises a plurality of wavelengths,
wherein a filter curve of the acousto-optic filter can be adjusted individually for each of the plurality of wavelengths.

17. The system according to claim 16,
wherein the at least one light source comprises a plurality of light sources for components of the light that correspond to the plurality of wavelengths,
wherein the exposure apparatus further comprises a beam-combining element, which combines partial beam paths of the plurality of light sources for the components of the light that correspond to the plurality of wavelengths,
wherein the acousto-optic filter is arranged, based on the beam-combining element, downstream along the partial beam paths.

18. The system according to claim 11,
wherein the at least one adjustable optical element splits the light at least into a first component and a second component,
wherein the system comprises a sensor which is configured to measure an intensity of the first component,
wherein the exposure apparatus is configured to implement the exposure process with the second component.

19. The system according to claim 18,
wherein the first component corresponds to an order of diffraction with a first polarization,
wherein the second component corresponds to a further order of diffraction with a second polarization,
wherein the order of diffraction differs from the further order of diffraction,
wherein the first polarization optionally differs from the second polarization.

20. The system according to claim 18, furthermore comprising:
a polarizing beam splitter arranged in the beam path of the first component and in the beam path of the second component.

21. The system according to claim 17, furthermore comprising:
an optical plate arranged in the beam path of the first component and in the beam path of the second component,
wherein the optical is arranged tilted relative to the beam path of the second component in such a way that it is incident on the optical plate at the Brewster's angle.

22. The system according to claim 11,
wherein the at least one adjustable optical element comprises a Pockels cell for changing the polarization by rotating a polarization plane.

23. The system according to claim 11,
wherein the at least one adjustable optical element comprises one or more lambda/2 plates, which can be introduced alternately into the beam path by means of a motor.

24. A method for controlling an exposure apparatus for producing a holographic optical element (HOE) by replicating a master HOE within the framework of an exposure process carried out by the exposure apparatus, wherein the exposure process uses light which is emitted from at least one light source of the exposure apparatus during the exposure process along a beam path to a surface of the carrier layer of the master HOE, wherein a carrier layer of the master HOE is arranged along a carrier layer of the HOE during the exposure process,
the method comprising the following steps:
controlling a beam movement unit of the exposure apparatus such that it moves the beam path during the exposure process in relation to the surface of the carrier layer of the master HOE, and
controlling at least one adjustable optical element of the exposure apparatus, with the former being arranged in the beam path, so that the at least adjustable optical element during the exposure process changes at least one of an intensity and a polarization of the light over time.

25. The method according to claim 24,
wherein at least the control of the at least one adjustable optical element and/or the beam movement unit is based on control data.

26. The method according to claim 24,
wherein the at least one adjustable optical element is controlled based on a closed control loop, which minimizes a deviation between a target intensity and an actual intensity of the light.

27. The method according to claim 24,
wherein the method is carried out by the control apparatus according to claim 1.
